(19) United States
(12) Patent Application Publication
(10) Pub. No.: US 2026/0019153 A1
(43) Pub. Date: Jan. 15, 2026

(54) OPTICAL DATA-CENTER COMMUNICATION SYSTEMS

(71) Applicant: X-Celeprint Limited, Dublin (IE)

(72) Inventors: Ronald S. Cok, Rochester, NY (US); Robert R. Rotzoll, Cascade, CO (US)

(21) Appl. No.: 19/259,115

(22) Filed: Jul. 3, 2025

Related U.S. Application Data
(60) Provisional application No. 63/670,496, filed on Jul. 12, 2024.

(51) Int. Cl. H04B 10/114; H04B 10/50; H04B 10/60

(52) U.S. Cl. CPC H04B 10/114; H04B 10/50; H04B 10/60

(57) ABSTRACT

A data-center communication system can include a first circuit board comprising an optical transmitter operable to emit light and a second circuit board comprising an optical receiver operable to receive the light. The first circuit board and the second circuit board can be disposed in a fixed spatial relationship with a rack. The light can be modulated optical signals. The first and second circuit boards can each include both optical transmitter and an optical receiver to enable bidirectional communication. Optical transmitters and optical receivers can enable point-to-point optical communications between circuit boards in a rack or can enable an optical bus shared by circuit boards in a rack.

### PRIORITY APPLICATION

This application claims the benefit of U.S. Provisional Patent Application No. 63/670,496, filed on Jul. 12, 2024, the disclosure of which is hereby incorporated by reference herein in its entirety.

### TECHNICAL FIELD

The present disclosure relates generally to optical communication systems for data centers.

### BACKGROUND

A data center is a facility with co-located computers (e.g., servers), data storage systems, and a communication network for communicating between the computers and data storage systems and for receiving or responding to processing or data requests from external computers or other telecommunications equipment (e.g., from the internet). The communication network can include electrical and optical devices such as routers and switches that transmit and receive data using electrical communications (e.g., using wires) and optical communications (e.g., using fiber optics). Data centers provide the systems for managing internet search queries and cloud computing, including executing programs. Recent increases in demand for compute intensive tasks such as physical modeling and training large language models have increased the demand for computing and communication resources.

The performance of data centers is limited by the available computing resources, the available storage systems, the available communication bandwidth between the computing resources, storage systems, and external computers or other telecommunications equipment, and the available power for these devices. In recent years, the available communication bandwidth and power increasing constrain the performance of a data center.

Optical communication for data transfer has been used for several decades for telecommunications and has also been proposed for local data communication. U.S. Pat. No. 5,224,184 discloses an optical multi-chip interconnect for inter-chip communications. U.S. Pat. No. 5,488,682 describes a polymer-based optical connector in a polymer backplane. U.S. Pat. No. 5,726,682 describes a free-space star-coupled optical data bus for broadcast communication between subsystems.

U.S. Pat. No. 6,650,844 discloses interconnecting circuit boards using free-space optics to provide a daisy-chain allowing any circuit board to communicate with any other circuit board through a common signal path. U.S. Pat. No. 6,872,007 discloses an optical line-of-sight inter-board data transfer configuration for adjacent circuit boards. Such designs can increase data transfer rates but there remains a need for data center system architectures that further improve bandwidth between components (e.g., computer servers and storage devices) in a data center, simplify construction, and that reduce power use.

### SUMMARY

The present disclosure provides, inter alia, architectures, structures, systems, devices, and methods for improved optical communication with reduced power and simplified, lower-cost construction between computing and storage components in a co-located facility, such as a data center or other internet-accessible computing-and-data storage facility.

According to embodiments of the present disclosure, a data-center communication system can comprise a first circuit board comprising an optical transmitter operable to emit light, a second circuit board comprising an optical receiver operable to receive the light. The first circuit board and the second circuit board are disposed in a fixed spatial relationship. In some embodiments, the optical transmitter can be a first optical transmitter, the optical receiver can be a first optical receiver, and the light can be first light. The second circuit board can comprise a second optical transmitter operable to emit second light from the second circuit board to the first circuit board and the first circuit board can comprise a second optical receiver operable to receive the second light. The data-center communication system can be mono-directional, transmitting light (e.g., comprising optical bits of information) from the first circuit board to the second circuit board or bidirectional, transmitting light (e.g., comprising optical bits of information) from the first circuit board to the second circuit board and also from the second circuit board to the first circuit board. In some embodiments, the first circuit board can comprise one or more electrically or optically connected computing components or storage components. One or more of the computing components and storage components, or both, can be connected to the optical transmitter. In some embodiments, the second circuit board can comprise one or more electrically or optically connected computing components or storage components. One or more of the computing components and storage components, or both, can be connected to the optical receiver.

In some embodiments, the first circuit board can comprise a first circuit-board substrate having opposed parallel surfaces and the second circuit board can comprise a second circuit-board substrate different, separate, and independent of the first circuit-board substrate. The second circuit-board substrate can have opposing parallel surfaces that are parallel to the opposing parallel surfaces of the first circuit-board substrate. The optical transmitter can be disposed on a first surface of the first circuit-board substrate, the optical receiver can be disposed on a second surface of the second circuit-board substrate, and the first circuit-board substrate and the second circuit-board substrate can be stacked so that a direction from the first circuit-board substrate to the second circuit-board substrate is at least partially orthogonal to the first surface or to the second surface. In some embodiments, the optical transmitter can be disposed on a first surface of the circuit-board substrate of the first circuit board, the optical receiver can be disposed on a second surface of the circuit-board substrate of the second circuit board, and the first surface and the second surface are adjacent so that the first and second surfaces face each other. In some other embodiments, the first surface and the second surface do not face each other so that, for example, another side of the second circuit board opposing the second side can be disposed between the first side and the second side. In some embodiments, the second circuit board is disposed in a direction orthogonal to a surface of the first circuit-board substrate. In some embodiments, the first circuit board and the second circuit board have a substantially same circuit-board substrate size.

In some embodiments of the present disclosure, at least a portion of the circuit-board substrate of the second circuit board is at least partially transparent to light emitted by the optical transmitter and the optical receiver on the second circuit board is disposed on a surface of the second circuit board opposite a surface of the second circuit board adjacent to the first circuit board. Thus, light emitted by the optical transmitter can pass through the transparent portion of the second circuit board to impinge upon the optical receiver. The transparent portion of the second circuit board can comprise a hole in the second circuit board or an at least partially transparent material that is at least partially transparent to the light emitted by the optical transmitter.

Some embodiments of data-center communication systems of the present disclosure can comprise a plurality of optical transmitters disposed on the first circuit board operable to emit light from the first circuit board to the second circuit board. Some embodiments of data-center communication systems of the present disclosure can comprise a plurality of optical receivers disposed on the second circuit board operable to receive light transmitted from the first circuit board to the second circuit board. Each of the optical receivers disposed on the second circuit board can be disposed to receive light from a corresponding one of the light transmitters disposed on the first circuit board. An exclusive subset of the optical receivers disposed on the second circuit board can be disposed to receive light from a corresponding one of the light transmitters disposed on the first circuit board.

In some embodiments, the optical transmitter (or optical transmitters) comprises a fractured or separated tether. In some embodiments, the optical receiver (or optical receivers) comprises a fractured or separated tether. The optical transmitter(s) can be disposed on a semiconductor substrate and the semiconductor substrate can be disposed on the first circuit board. The optical receiver(s) can be disposed on a semiconductor substrate and the semiconductor substrate can be disposed on the second circuit board.

Some embodiments of the present disclosure can comprise a third circuit board. A light receiver can be disposed on the third circuit board to receive light from the first circuit board. A light transmitter can be disposed on the third circuit board to transmit light to the first circuit board.

In some embodiments, the second circuit board is at least partially transparent to light emitted by the light transmitter on the first circuit board. In some embodiments, the second circuit board is at least partially transparent to light emitted by the light transmitter on the third circuit board. The optical transmitter disposed on the first circuit board can be a first optical transmitter and embodiments can comprise a second optical transmitter disposed on the second circuit board operable to emit light from the second circuit board to the third circuit board. In some embodiments, the light emitted from the first circuit board to the second circuit board can be an optical signal and the light emitted from the second circuit board to the third circuit board can transmit substantially the same optical signal, a modified optical signal comprising some portions of the optical signal, or a new optical signal. In embodiments, the second circuit board can comprise a hole through which emitted light can pass. In some embodiments, transmit/receive pairs of optical transmitters and optical receivers can be in a fixed spatial relationship and different transmit/receive pairs can be disposed in unrelated locations on their respective circuit boards, for example disposed in an irregular arrangement.

In some embodiments, transmit/receive pairs of optical transmitters and optical receivers on each circuit board in a stack of circuit boards can form an optical bus, e.g., a. circulating or re-circulating optical bus that circulates or re-circulates data.

In some embodiments of the present disclosure, the circuit boards comprise four circuit boards each having a surface, and the four circuit boards are arranged as the sides of a square with the surfaces facing the inside of the square (e.g., the surface on which the optical transmitter or optical receiver is disposed, so that the circuit boards are disposed as the sides of a box excluding the top and bottom of the box. Some embodiments comprise an optical element disposed within the square operable to reflect light from each circuit board to or from one or more of the other circuit boards. Some embodiments comprise a chilled fluid (e.g., a gas or liquid) disposed to flow through the center of the square or within the square. The four circuit boards can form a data square and embodiments can comprise a plurality of data squares, each data square operable to transmit or receive light from another data square. The data squares can be arranged in a two-dimensional array.

In some embodiments of the present disclosure, the circuit boards can comprise six circuit boards each having a surface, and the six circuit boards can be arranged as the sides of a cube with the surfaces facing the inside of the cube. In embodiments, an optical element can be disposed in the cube operable to reflect light from each circuit board to or from one or more of the other circuit boards. The six circuit boards can form a data cube and embodiments can comprise a plurality of data cubes, each data cube operable to transmit or receive light from another data cube. The data cubes can be arranged in a two-dimensional array. The data cubes can be arranged in a three-dimensional array. Some embodiments can comprise a chilled fluid disposed to flow between the data cubes, for example through the circuit boards or gaps disposed between the circuit boards.

In some embodiments, one or both of the first circuit board and the second circuit board (i) are adjacent to or in contact with a cooling structure through which chilled fluid can flow and/or (ii) comprise one or more cooling channels through which chilled fluid can flow.

Embodiments of the present disclosure can comprise a repeater circuit board comprising a circuit-board substrate with a surface, one or more processing, storage, or communication circuits disposed on the surface, an optical transmitter disposed on the circuit-board substrate and operable to emit light in a first direction at least partially orthogonal to the surface, and an optical receiver disposed on the circuit-board substrate and operable to receive light from a second direction. The second direction can be at least partially the same as the first direction or substantially the same as the first direction, e.g., within manufacturing tolerances. In some embodiments, the circuit-board substrate can comprise one or more cooling channels through which chilled fluid can flow. In some embodiments, the circuit-board substrate comprises multiple circuit-board substrates and a cooling structure is disposed between two of the multiple circuit-board substrates.

Embodiments of the present disclosure can comprise a reflector circuit board comprising a circuit-board substrate with a surface, one or more processing, storage, or communication circuits disposed on the surface, an optical transmitter disposed on the circuit-board substrate and operable to emit light in a first direction at least partially orthogonal to the surface, and an optical receiver disposed on the circuit-board substrate and operable to receive light from a second direction. The second direction can be at least partially opposite the first direction or substantially opposite the first direction, e.g., within manufacturing tolerances.

According to embodiments of the present disclosure, a data-center communication system can comprise a first circuit board comprising a first optical transmitter operable to emit first light of a first frequency (e.g., color) and a second optical transmitter operable to emit light of a second frequency (e.g., color) different from the first frequency and a second circuit board comprising a first optical receiver operable to receive the first light and a second optical receiver operable to receive the second light. The first circuit board and the second circuit board can be adjacent circuit boards disposed in a fixed spatial and aligned relationship. The light can be modulated light encoding information. In embodiments, the second circuit board comprises a third optical transmitter operable to emit light of the first frequency and a fourth optical transmitter operable to emit light of the second frequency and the first circuit board comprises a third optical receiver operable to receive the light from the third optical transmitter and a fourth optical receiver operable to receive the light from the fourth optical transmitter. Thus, the first circuit board and the second circuit board form a pair of circuit boards having bidirectional optical communication. The emitted light can be collimated light or uncollimated light. The first circuit board can have a surface on which is disposed the first optical transmitter and the second optical transmitter and embodiments can comprise a light-absorbing wall that extends from the surface toward the second circuit board (e.g., extends a distance no less than a height that the first or second optical transmitter extends from the surface, extends a distance greater than a height that the first or second optical transmitter extends from the surface, extends a distance no less than 1.5, two, three, or four times height that the first or second optical transmitter extends from the surface).

According to embodiments of the present disclosure, a data-center communication system can comprise a first circuit board comprising a first optical transmitter operable to emit first light, a second circuit board comprising a first optical receiver operable to receive the first light and a second optical transmitter operable to emit second light, and a third circuit board comprising a second optical receiver operable to receive the second light. The first circuit board, the second circuit board, and the third circuit board can be disposed in a fixed and aligned spatial relationship. The first light and the second light can be modulated light encoding information. The second circuit board can be operable to decode the received first light from the first circuit board to extract the information and modulate the second light with at least some of the information to re-transmit the at least some of the information to the third circuit board. Some embodiments comprise an optical bus (e.g., a repeating, circulating, or re-circulating optical bus) in which information provided by the first circuit board can be optically transmitted to the second circuit board and the second circuit board optically transmits at least some of the information to the third circuit board.

According to embodiments of the present disclosure, a data-center communication system can comprise a first circuit board comprising a first optical transmitter operable to emit first light and a second optical receiver operable to receive second light and a second circuit board comprising a first optical receiver operable to receive the first light and a second optical transmitter operable to emit second light. The first circuit board and the second circuit board can be adjacent in a stack and can be disposed in a fixed and aligned spatial relationship. The first light and the second light can be modulated light encoding information. The first circuit board can be operable to decode the received second light from the second circuit board to extract the information and modulate the first light with at least some of the information to re-transmit the at least some of the information to the second circuit board. Some embodiments can comprise a reflecting optical bus in which at least some information optically transmitted by the second circuit board to the first circuit board can be optically transmitted from the second circuit board back to the first circuit board.

According to embodiments of the present disclosure, a data-center communication system can comprise a stack of circuit boards disposed in a rack. The stack of circuit boards can comprise a top circuit board disposed at the top (e.g., one end) of the stack that is a reflector circuit board, a bottom circuit board disposed at the bottom (e.g., an opposite end from the top end) of the stack that is a reflector circuit board, and one or more repeater circuit boards disposed between the top circuit board and the bottom circuit board in the stack. The repeater circuit boards can comprise optical receivers operable to optically receive information from an adjacent repeater circuit board on a first side of the repeater circuit board and optical transmitters operable to transmit at least some of the received information to an adjacent repeater circuit board on a second side of the repeater circuit board opposite the first side. The top and bottom reflector circuit boards can comprise optical receivers operable to optically receive information from an adjacent repeater circuit board and optical transmitters operable to transmit at least some of the received information back to the adjacent repeater circuit board. For the repeater circuit boards, the optical transmitters can be first optical transmitters, the optical receivers can be first optical receivers, and embodiments can comprise second optical transmitters operable to optically transmit information to an adjacent repeater circuit board on the first side of the repeater circuit board and second optical receivers operable to optically receive information from an adjacent repeater circuit board on the second side of the repeater circuit board. A first repeater circuit board can be disposed adjacent to a second repeater circuit board in the stack, the optical receivers on the first repeater circuit board can be disposed in a first receiver location, the optical transmitters on the first repeater circuit board can be disposed in a first transmitter location, the optical receivers on the second repeater circuit board can be disposed in a second receiver location, the optical transmitters on the second repeater circuit board can be disposed in a second transmitter location, the first transmitter location of the first repeater circuit board can correspond to the second receiver location of the second repeater circuit board, and the first receiver location of the first repeater circuit board can correspond to the second transmitter location of the second repeater circuit board. In some embodiments, a third repeater circuit board can be disposed adjacent to the second repeater circuit board in the stack, the optical receivers on the third repeater circuit board can be disposed in a third receiver location, the optical transmitters on the third repeater circuit board can be disposed in a third transmitter location, and the first receiver location of the first repeater circuit board can correspond to the third transmitter location of the third repeater circuit board and the first transmitter location of the first repeater circuit board can correspond to the third receiver location of the third repeater circuit board. Thus, the locations of an optical receiver and an optical transmitter on surfaces of adjacent circuit boards can correspond in a direction orthogonal to the surfaces and the locations can alternate between adjacent pairs of circuit boards (e.g., locations on first and second circuit boards can alternate with locations on second and third circuit boards).

According to some embodiments of the present disclosure, a data-center communication system can comprise a first circuit board comprising a first optical transmitter operable to emit first light and a second optical transmitter operable to second light different from the first light, a second circuit board comprising a first optical receiver operable to receive the first light and a third optical transmitter operable to emit third light different from the first light and from the second light, and a third circuit board comprising a second optical receiver operable to receive the second light and a third optical receiver operable to receive the third light. The first circuit board, the second circuit board, and the third circuit board can be disposed in a fixed spatial relationship. The light can be modulated light encoding information. The second circuit board can comprise a hole or have at least a transparent material portion through which the third light passes undetected.

In embodiments of the present disclosure, a circuit board for optical communication can comprise a circuit-board substrate having a surface, an optical transmitter disposed on the surface operable to emit light in a direction, and an optical receiver disposed on the surface operable to receive light from the same direction. The circuit-board substrate can be at least partially transparent to light emitted by the optical transmitter or received by the optical receiver. The optical transmitter can be disposed and operable to emit light in a direction away from the circuit-board substrate and the optical receiver can be disposed and operable to receive light through the circuit-board substrate. The optical transmitter can be disposed and operable to emit light through the circuit-board substrate and the optical receiver can be disposed and operable to receive light in a direction away from the circuit-board substrate. The optical transmitter can be disposed adjacent to the optical receiver (e.g., on the circuit-board substrate). The optical transmitter can be disposed adjacent to the optical receiver (e.g., on the circuit-board substrate).

According to embodiments of the present disclosure, a data-center communication system can comprise a first circuit board comprising an optical transmitter operable to emit light and a second circuit board comprising multiple optical receivers operable to receive the light. The first circuit board and the second circuit board can be disposed in a fixed and aligned spatial relationship. Some embodiments comprise multiple optical transmitters operable to emit light disposed on the first circuit board and multiple optical receivers operable to receive the light from each optical transmitter disposed on the second circuit board. The multiple optical receivers operable to receive the light from one of the optical transmitters can be disposed adjacent to each other on the second circuit board. Some embodiments comprise optical transmitters disposed on the second circuit board and the multiple optical receivers operable to receive the light from one of the optical transmitters on the first circuit board can be disposed adjacent to an optical transmitter on the second circuit board. Some embodiments can comprise optical transmitters and the optical receivers disposed on the second circuit board can be interdigitated, for example interdigitated or interspersed in a checkerboard, alternating rows, or alternating columns. In some embodiments, the optical receivers can surround the optical transmitters in one or two dimensions on the second circuit board.

According to some embodiments of the present disclosure, the optical transmitter can be disposed in a location on the first circuit board corresponding to a location of the optical receiver on the second circuit board (e.g., in a same overlapping location in a direction orthogonal to a surface of the first or second circuit board on which is mounter the optical transmitter or optical receiver). In some embodiments, the optical transmitter can be disposed in a first location on a first side of the circuit-board substrate and the optical receiver can be disposed in a second location on a second side of the circuit-board substrate opposite the first side. The first location can correspond to or overlap the second location in a direction orthogonal to a surface of the circuit-board substrate on which the optical transmitter is disposed or on which the optical receiver is disposed. In some embodiments, the optical transmitter can be a first optical transmitter and the optical receiver can be a first optical receiver. Embodiments can comprise a second optical receiver disposed in a third location on the first side of the circuit-board substrate and a second optical transmitter disposed in a fourth location on the second side of the circuit-board substrate. The third location can correspond to (or overlap with) the fourth location in a direction orthogonal to a surface of the circuit-board substrate on which the second optical transmitter is disposed or on which the second optical receiver is disposed. In embodiments, the optical transmitters and the optical receivers disposed on the first side and the second side can be interdigitated in a checkerboard, alternating rows, or alternating columns arrangement so that optical transmitters on the first side can have a location that corresponds to the location of the optical receivers on the second side, and vice versa.

Embodiments of the present disclosure provide improvements in data communication between circuit boards in a computing system. The computing system can comprise processors, storage devices, and a communication network.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1A is a perspective of a data-center communication system comprising two circuit boards according to illustrative embodiments of the present disclosure;

FIG. 1B is a cross section of the data-center communication system of FIG. 1A according to illustrative embodiments of the present disclosure;

FIG. 1C is a cross section of the data-center communication system of FIG. 1A further comprising a rack for securing the circuit boards in a fixed spatial relationship according to illustrative embodiments of the present disclosure;

FIG. 1D is a perspective of a data-center communication system comprising optical transmitter and optical receiver pairs disposed on circuit-board substrates in unrelated locations according to illustrative embodiments of the present disclosure;

FIG. 2A is a perspective of a data-center communication system comprising two bidirectional circuit boards according to illustrative embodiments of the present disclosure;

FIG. 2B is a cross section of the bidirectional data-center communication system of FIG. 2A according to illustrative embodiments of the present disclosure;

FIG. 2C is a cross section of the bidirectional data-center communication system of FIG. 2A comprising optical structures according to illustrative embodiments of the present disclosure;

FIG. 3A is a perspective of a data-center communication system comprising three circuit boards according to illustrative embodiments of the present disclosure;

FIG. 3B is a cross section of the data-center communication system of FIG. 3A according to illustrative embodiments of the present disclosure;

FIG. 4 is a cross section of a bidirectional data-center communication system comprising a repeater circuit board and two reflector circuit boards according to illustrative embodiments of the present disclosure;

FIG. 5 is a cross section of a data-center communication system comprising at least partially transparent circuit-board substrates with point-to-point optical communication according to illustrative embodiments of the present disclosure;

FIG. 6 is a cross section of a data-center communication system comprising at least partially transparent vias in circuit-board substrates mounted in a rack with point-to-point optical communication according to illustrative embodiments of the present disclosure;

FIG. 7 is a cross section of a data-center communication system comprising three directly communicating circuit boards with point-to-point optical communication according to illustrative embodiments of the present disclosure;

FIG. 8A is a perspective of a circuit board useful for a data-center communication system comprising optical transmitters and receivers on a common side of the circuit-board substrate according to illustrative embodiments of the present disclosure;

FIG. 8B is a cross section of a data-center communication system comprising alternating and interdigitated optical transmitters and optical receivers on a common surface of a circuit-board substrate according to illustrative embodiments of the present disclosure;

FIG. 8C is a cross section of a data-center communication system with reversed alternation from the alternation of FIG. 8B according to illustrative embodiments of the present disclosure;

FIG. 9A is a perspective of a circuit board useful for a data-center communication system comprising optical transmitters and receivers on a common side of a circuit-board substrate with groups of optical receivers surrounding optical transmitters according to illustrative embodiments of the present disclosure;

FIG. 9B is a cross section of FIG. 9A taken across a row of optical transmitters and optical receivers according to illustrative embodiments of the present disclosure;

FIG. 10A is a cross section of a circuit board useful for a data-center communication system comprising optical transmitters and receivers on a common side of a circuit-board substrate receiving light through the circuit-board substrate according to illustrative embodiments of the present disclosure;

FIG. 10B is a cross section of a circuit board useful for a data-center communication system comprising optical transmitters and receivers on a common side of a circuit-board substrate transmitting light through the circuit-board substrate according to illustrative embodiments of the present disclosure;

FIG. 11 is a cross section of optical transmitters that emit different frequencies of light from a first circuit board and optical receivers that capture different frequencies of light on a second circuit board in a rack of circuit boards according to illustrative embodiments of the present disclosure;

FIG. 12 is a cross section and inset of a micro-transfer-printed optical transmitter or receiver together with a native circuit in a data-center communication system according to illustrative embodiments of the present disclosure;

FIG. 13 is a perspective of stacks of circuit boards in a data-center communication system according to illustrative embodiments of the present disclosure;

FIG. 14A is a perspective of a square of inter-communicating circuit boards in a data-center communication system according to illustrative embodiments of the present disclosure;

FIG. 14B is a perspective of inter-communicating squares of circuit boards in a data-center communication system according to illustrative embodiments of the present disclosure;

FIG. 15A is a perspective of a cube of inter-communicating circuit boards in a data-center communication system according to illustrative embodiments of the present disclosure;

FIG. 15B is a perspective of inter-communicating cubes of circuit boards in a data-center communication system according to illustrative embodiments of the present disclosure;

FIG. 15C is a perspective of inter-communicating cubes of circuit boards having shared sides in a data-center communication system according to illustrative embodiments of the present disclosure;

FIG. 16 is a flow diagram of data-center communication system methods according to illustrative embodiments of the present disclosure;

FIG. 17 is a cross section of a data-center communication system comprising one or more cooling structures, according to illustrative embodiments of the present disclosure;

FIG. 18 is a cross section of a cooling structure comprising optical vias, according to illustrative embodiments of the present disclosure;

FIG. 19 is a cross section of a circuit board comprising one or more cooling structures, according to illustrative embodiments of the present disclosure; and

FIG. 20 is a cross section of a circuit board comprising one or more cooling structures, according to illustrative embodiments of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The figures are not necessarily drawn to scale.

### DETAILED DESCRIPTION OF CERTAIN EMBODIMENTS

Data-center systems providing computation and information retrieval can be significantly limited by inter-processor communication bandwidth constraints. Embodiments of the present disclosure provide improved communication bandwidth between circuit boards in a data communication system using optical communication between boards, for example, using at least partially free-space optical communication. Circuit boards mounted in a rack or card cage of circuit boards can emit modulated light directly from one board to an adjacent or neighboring circuit board or to other circuit boards in the rack.

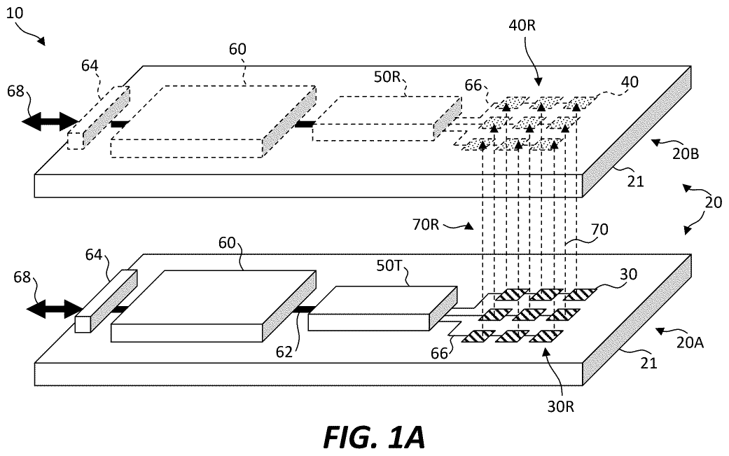

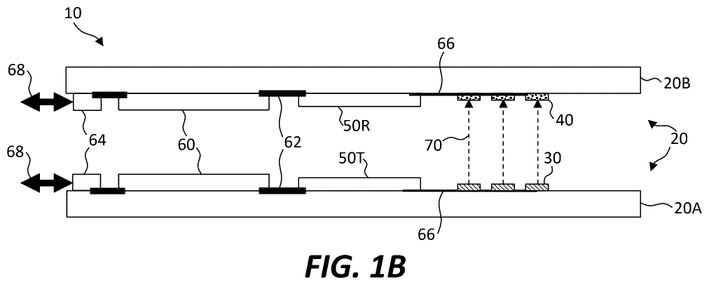

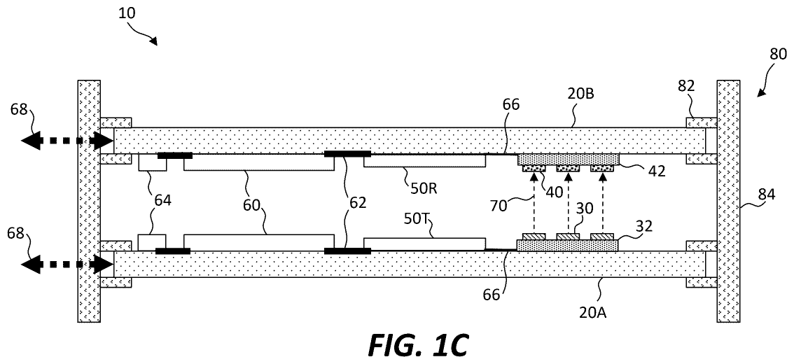

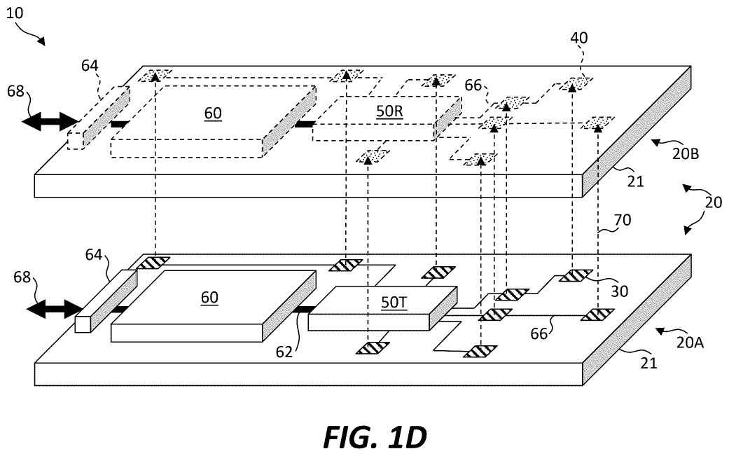

According to embodiments of the present disclosure and as illustrated in FIGS. 1A, 1B, and 1C, a data-center communication system 10 comprises a first circuit board 20A comprising an optical transmitter 30 or multiple optical transmitters 30 (e.g., a light emitter 30 or multiple light emitters 30) operable to emit light 70 and a second circuit board 20B different from first circuit board 20A comprising an optical receiver 40 (e.g., a light sensor 40 or multiple light sensors 40) operable to receive or capture emitted light 70. Light 70 can also be a light beam 70, a light ray 70, photons 70, or an optical signal 70. First circuit board 20A and second circuit board 20B are disposed in a fixed and aligned spatial relationship that enables light 70 emitted from optical transmitter 30 to be received by optical receiver 40 along a pre-determined, fixed optical path, for example in a direction at least partially or substantially orthogonal to a surface of first or second circuit board 20A, 20B on which is mounted optical transmitter 30 or optical receiver 40.

First circuit board 20A and second circuit board 20B are collectively referred to as circuit boards 20. Each circuit board 20 can comprise a circuit-board substrate 21 having opposing surfaces (or sides) on either or both of which integrated circuits (e.g., optical transmitter 30, optical receiver 40, or processing, storage, communication, or control circuits) can be disposed or mounted. Thus, first circuit-board 20A can comprise a first circuit-board substrate 21 and second circuit-board 20B can comprise a second circuit-board substrate 21 different, independent, and separate from first circuit-board substrate 21.

Optical transmitter 30 can be disposed on a surface of first circuit-board substrate 21 of first circuit board 20A and optical receiver 40 can be disposed on a surface of second circuit-board substrate 21 of second circuit board 20B. In embodiments, optical transmitter 30 emits light 70 in a direction at least partially or substantially orthogonal to the surface of first circuit board 20A and optical receiver 40 receives light 70 from a direction at least partially or substantially orthogonal to the surface of second circuit board 20B. The surfaces of first circuit board 20A and second circuit board 20B can be substantially parallel. As shown in FIG. 1C, first circuit-board substrate 21 of first circuit board 20A and second circuit-board substrate 21 of second circuit board 20B can be held in a fixed and aligned spatial relationship with a rack 80 (e.g., a card cage or frame for physically securing circuit boards 20 in a pre-determined spatial relationship) comprising slides 82 that can receive and hold (e.g., with latches) each of first circuit board 20A and second circuit board 20B in position with respect to a mount 84. Rack 80 can position first circuit board 20A and second circuit board 20B in a horizontal or vertical (or any) spatial orientation with respect to the direction of gravity. Rack 80 can hold any useful number of circuit boards 20 in a fixed relative position or spatial relationship, e.g., two, three, four, five, eight, ten, twelve, fifteen, twenty, twenty-five, thirty, forty, fifty, or sixty-four circuit boards 20. Circuit boards 20 can comprise hardware or logic, or both, to determine a relative position in the stack in rack 80. The position information can be used to intelligently control communication and computation in circuit board 20 and with respect to other circuit boards 20.

Light 70 can be modulated by optical transmitter 30 to carry and transmit information (e.g., binary information or bits of data such as optical data). Optical receiver 40 can receive and capture modulated light 70. First circuit board 20A can comprise control circuits (e.g., integrated circuits) to control optical transmitters 30 to modulate light 70 in response to data (e.g., binary information such as binary signals that are optical bits in an optical signal 70) to provide optical bits. Second circuit board 20B can comprise control circuits (e.g., integrated circuits) to control optical receivers 40 to receive and capture modulated light 70 and process modulated light 70 to determine transmitted binary information. Thus, data-center communication system 10 is operable to communicate data or information (e.g., bits) from first circuit board 20A to second circuit board 20B using optical signals 70. In some embodiments, different circuit boards 20 emit light 70 at different frequencies that can be detected and used to differentiate signals from the different circuit boards 20. In some embodiments, a single transmitting circuit board 20 emit lights 70 at different frequencies that can all be detected and used by a single, separate receiving circuit board 20.

In some embodiments, optical transmitter 30 can be disposed on a first side (or first surface) of first circuit-board substrate 21 of first circuit board 20A and optical receiver 40 can be disposed on a second side (or second surface) of second circuit-board substrate 21 of second circuit board 20B. The first side can be facing and adjacent to the second side. In other embodiments, and as discussed further below, optical transmitter 30 and optical receiver 40 are not on facing and adjacent sides (surfaces) of first and second circuit-board substrates 21. Adjacent sides or surfaces of circuit-board substrates 21 are sides or surfaces of circuit-board substrates 21 between which there are no other sides or surfaces of a circuit-board substrate 21. Generally, a side or surface of a circuit-board substrate 21 is a side or surface on which optical transmitter 30 or optical receiver 40 (or another integrated circuit) is disposed or mounted or a side or surface substantially parallel to (e.g., within manufacturing tolerances) and different from the side or surface on which optical transmitter 30 or optical receiver 40 (or another integrated circuit) is disposed or mounted.

In embodiments, a first surface of circuit-board substrate 21 of first circuit board 20A and a second surface of circuit-board substrate 21 of second circuit board 20B are substantially parallel so that second circuit board 20B is located away from first circuit-board 20A in a direction that is substantially orthogonal (e.g., within manufacturing limits or tolerances) to the first surface of circuit-board substrate 21 of first circuit board 20A. In other words, circuit boards 20 with substantially parallel surfaces on which are mounted optical transmitters 30 or optical receivers 40 or other integrated circuits are stacked, as shown in FIGS. 1A-1C. Thus, optical transmitters 30 disposed on first circuit-board substrate 21 can emit light 70 in a direction substantially orthogonal (or at least partially orthogonal) to the first surface of circuit-board substrate 21 of first circuit board 20A on which optical transmitters 30 are disposed (and therefore in a direction that is also substantially or partially orthogonal to the second surface of circuit-board substrate 21 of second circuit board 20B on which optical receivers 40 are disposed). Likewise, optical receivers 40 disposed on second circuit-board substrate 21 can receive (e.g., input, capture, or absorb) light 70 from a direction substantially orthogonal (or at least partially orthogonal) to the second surface of circuit-board substrate 21 of second circuit board 20B on which optical receivers 40 are disposed (and therefore in a direction that is also substantially or partially orthogonal to the first surface of circuit-board substrate 21 of first circuit board 20A on which optical transmitters 30 are disposed). Thus, according to some embodiments of the present disclosure, circuit boards 20 each comprise a circuit-board substrate 21 having opposing surfaces, optical transmitter 30 is disposed on a first surface of first circuit-board substrate 21 of first circuit board 20A, optical receiver 40 is disposed on a second surface of second circuit-board substrate 21 of second circuit board 20B, and the second surface of second circuit-board substrate 21 of second circuit board 20B is disposed in a direction at least partially orthogonal to the first surface of first circuit-board substrate 21 of first circuit board 20A.

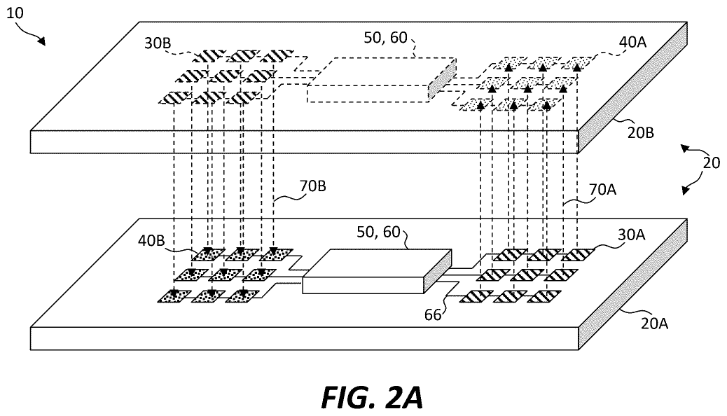

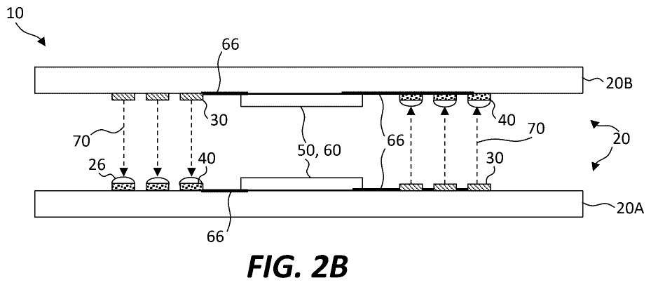

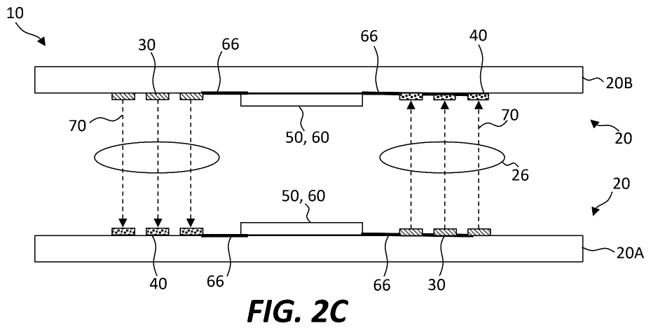

In embodiments, first circuit board 20A and second circuit board 20B are disposed relative to and in a fixed and pre-determined spatial relationship to each other to enable light 70 transmission from optical transmitter 30 on first circuit board 20A to optical receiver 40 on second circuit board 20B at least partially through free space, for example not exclusively (e.g., within manufacturing limitations or tolerances) using wave guides, optical fibers 68, or light pipes formed in or attached to either first circuit-board substrate 21 of first circuit board 20A or second circuit-board substrate 21 of second circuit board 20B. In some embodiments, light 70 is transmitted from first circuit board 20A to second circuit board 20B substantially or exclusively through free space. Optical transmitter 30 on first circuit board 20A can be arranged and disposed (e.g., spatially located and at an appropriate angle) so that emitted light 70 is effectively received by optical receiver 40 on second circuit board 20B. In some embodiments, an optical structure 26 (e.g., lenses as shown in FIG. 2C) can be disposed between first and second circuit boards 20A, 20B. In some embodiments, micro-lenses (e.g., lenslets, shown in FIG. 2B) can be disposed on or over either or both of optical transmitters 30 and optical receivers 40. However, in embodiments of the present disclosure, light 70 travels between first and second circuit boards 20A, 20B at least partially through free space, for example through free space between first and second circuit boards 20A, 20B, for example in a direction orthogonal to a surface of a circuit-board substrate 21 on which are disposed optical transmitters 30 or optical receivers 40.

As shown in FIGS. 1A-1C and in some embodiments of the present disclosure circuit boards 20 can comprise multiple optical transmitters 30 (for example disposed in an array 30R of optical transmitters 30 on first circuit-board substrate 21 of first circuit board 20A) that emit an array 70R of light 70 beams or optical signals 70 or multiple optical receivers 40 (for example disposed in an array 40R of optical receivers 40 on second circuit-board substrate 21 on second circuit board 20B) that capture an array 70R of light 70 beams or optical signals 70. Each optical transmitter 30 on first circuit-board substrate 21 of first circuit board 20A can be spatially arranged to emit light 70 to a single optical receiver 40 on second circuit-board substrate 21 of second circuit board 20B (as shown in FIGS. 1A-1C). In embodiments, first circuit board 20A can comprise a same number of optical transmitters 30 as optical receivers 40 comprised in second circuit board 20B. In some embodiments, each optical transmitter 30 can be arranged to emit light 70 to multiple optical receivers 40. In embodiments, first circuit board 20A can comprise fewer optical transmitters 30 than optical receivers 40 comprised in second circuit board 20B.

In some embodiments, wires or waveguides 66 (in aggregate, wire or waveguide buses 62) connect rows or columns of optical transmitters 30 disposed in an array 30R and transmitter controller 50T controls array 30R of optical transmitters 30 using matrix addressing. Similarly, in some embodiments, wires or waveguides 66 (in aggregate, wire or waveguide buses 62) connect rows or columns of optical receivers 40 disposed in an array 40R and receiver controller 50R controls array 40R of optical receivers 40 using matrix addressing. In some embodiments, both optical transmitters 30 can be controlled using matrix addressing and optical receivers 40 can be controlled using matrix addressing.

In some embodiments, wires or waveguides 66 can electrically or optically connect each optical transmitter 30 to transmitter controller 50T individually and separately and each optical transmitter 30 can operate independently of any or every other optical transmitter 30 and optical transmitters 30 are not, therefore, matrix-address controlled. Similarly, in some embodiments, wires or waveguides 66 can electrically connect each optical receiver 40 to receiver controller 50R individually and separately and each optical receiver 40 can operate independently of any or every other optical receiver 40 and optical receivers 40 are not, therefore, matrix-address controlled.

Transmitter controller 50T and receiver controller 50R can be generically referred to as transmitter/receivers 50. In some embodiments, transmitter/receivers 50 can control light 70 output from optical transmitters 30 and light 70 received from optical receivers 40, for example in a common circuit, multiple circuits in a common integrated circuit, or in separate integrated circuits disposed on a common circuit board 20 or side or surface of a circuit board 20 or circuit-board substrate 21.

Circuit boards 20 can comprise any one or combination of integrated processor, storage, communication, and routing circuits 60 that provide computation (e.g., micro-processors), storage devices (e.g., memories, disks), or communication (e.g., routers) and use information transmitted from optical transmitters 30 and received by optical receivers 40, for example to provide data-center computational and data-access services. Circuit boards 20 can also comprise conventional communication circuits (e.g., electrical/optical input/output circuits 64) and electrical or optical connections (e.g., optical fiber 68) to communicate through fiber optical connections, wire or waveguide buses 62, and routers to other circuit boards 20, for example not in a common stack of circuit boards 20 and not through free space.

According to embodiments of the present disclosure, circuit board 20 comprises at least one of optical transmitter 30 or optical receiver 40, or both at least one of optical transmitter 30 and one of optical receiver 40. In some embodiments, circuit board 20 comprises a transmitter/receiver controller 50 connected to one or more integrated processor/storage or communication/routing circuits 60. Integrated processor/storage circuits 60 or communication/routing circuits 60 (or both) can be processors or storage devices (or both processors and storage devices) providing computation or data retrieval in a data center (e.g., can provide central processing unit “cores” that can execute instructions). Circuit board 20 can comprise a circuit-board substrate 21 on which is disposed one or more of optical transmitter 30, optical receiver 40, wires or waveguides 66, and integrated circuits (e.g., transmitter/receiver controllers 50, processor/storage circuits, and input/output circuit 64) on one side or surface or on both of two opposing sides or surfaces. Thus, in some embodiments, first circuit board 20A can comprise one or more electrically or optically connected computing components, storage components, and/or communication components. The one or more of the computing components and storage components can be connected to optical transmitter 30. Similarly, in some embodiments, second circuit board 20B can comprise one or more electrically or optically connected computing components, storage components, and/or communication components. The one or more of the computing components, storage components, and/or communication components can be connected to optical receiver 40.

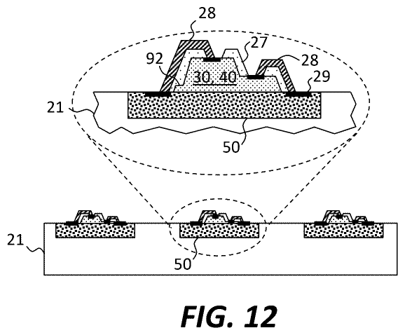

Circuit board 20 can be fiber glass, glass, or plastic, or any suitable substrate for photolithographic or printed-circuit-board processing, the construction of wires or waveguides 66, and integrated circuit mounting, for example using pick-and-place assembly, surface mount deposition, or micro-transfer printing. In embodiments comprising micro-transfer-printed optical transmitters 30 or optical receivers 40, each of optical transmitters 30 can comprises a fractured or separated tether 92, each of optical receivers 40 can comprise a fractured or separated tether 92, or both (as shown in FIG. 12, discussed below). First circuit board 20A and second circuit board 20B can be substantially the same size (e.g., the same circuit-board substrate 21 size) or, in some embodiments, have different sizes.

Optical transmitters 30 can be light-emitting diodes (e.g., organic or inorganic light-emitting diodes), laser diodes, or vertical cavity surface emission lasers (VCSELS) electrically connected to transmitter controller 50T with wires 66 on circuit board 20 (and optionally on a transmitter substrate 32). Optical transmitters 30 can comprise compound semiconductor materials. Optical receivers 40 can be inorganic photo-diodes, photo-sensors, or photo-transistors electrically connected to receiver controller 50R with wires 66 on circuit board 20 (and optionally on a receiver substrate 42). In some embodiments, a transmitter substrate 32 can comprise a compound semiconductor and one or more optical transmitters 30 can be formed in or on transmitter substrate 32. Optical receivers 40 can comprise compound semiconductor materials or silicon. In some embodiments, a receiver substrate 42 can comprise silicon (or a compound semiconductor) and one or more optical receivers 40 can be formed in or on receiver substrate 42 (as well as control circuits).

In some embodiments of the present disclosure, optical transmitter 30 and optical receiver 40 are advantageously micro-transfer-printed micro-devices providing a large communication bandwidth in a small area of circuit board 20 and can be micro-transfer printed onto circuit board 20 from a source wafer or formed in a semiconductor substrate mounted onto circuit board 20 (e.g., a transmitter substrate 32 or receiver substrate 42). In some embodiments, optical transmitters 30 are disposed on transmitter substrate 32 mounted on circuit board 20, optical receivers 40 are disposed on receiver substrate 42 mounted on circuit board 20, or both, as shown in FIG. 1C. In some embodiments, optical transmitters 30 and optical receivers 40 are both mounted on a common communication substrate disposed on circuit board 20 (not shown in the Figures). By disposing optical transmitters 30 and optical receivers 40 on a substrate separate from circuit board 20, optical transmitters 30 and optical receivers 40 can be made at a greater density than integrated circuits on circuit board 20 and can be tested before disposition on circuit-board substrate 21 to provide a known-good module, thus reducing costs for circuit board 20.

FIGS. 1A, 1B, and 1C illustrate embodiments in which optical transmitters 30 and optical receivers 40 are disposed in related locations on first circuit board 20A and second circuit board 20B, respectively, for example optical transmitters 30 in an array 30R with a fixed spacing between optical transmitters 30 and optical receivers 40 in an array 40R with a fixed or regular spacing between optical receivers 40 so that each location depends on another location in the array. In some embodiments and as illustrated in FIGS. 1A, 1B, and 1C, optical transmitters 30 can be disposed in an array and controlled through rows of wires or waveguides 66 and columns of wires or waveguides 66 respectively connected to rows of optical transmitters 30 and columns of optical transmitters 30 using matrix addressing by transmitter controller 50T. Similarly, optical receivers 40 can be disposed in an array and controlled through rows of wires or waveguides 66 and columns of wires or waveguides 66 respectively connected to rows of optical receivers 40 and columns of optical receivers 40 using matrix addressing by receiver controller 50R.

In some other embodiments and as shown in FIG. 1D, the locations of optical transmitters 30 on first circuit board 20A are unrelated and are not in a fixed or regular (e.g., are in an irregular) spatial relationship with each other and optical receivers 40 on second circuit board 20B are not in a fixed (e.g., are in an irregular) spatial relationship with each other. Pairs of optical transmitters 30 and optical receivers 40 can have a fixed spatial relationship (e.g., so that light 70 can be transmitted from optical transmitter 30 to optical receiver 40 in a pair) but the pairs of optical transmitters 30 and optical receivers 40 are not in a fixed spatial relationship with other pairs of optical transmitters 30 and optical receivers 40. In some designs, for example, the space between optical transmitters 30 and optical receivers 40 can vary or can be irregular. Indeed, and as shown in FIG. 1D, other integrated circuits (such as transmitter/receiver controllers 50 or processor/storage and/or communication circuits 60) can be spatially disposed between optical transmitters 30 on circuit-board substrate 21. The same can be true for optical receivers 40. Such arrangements can provide more flexibility in optical transmitter 30 and optical receiver 40 layout on circuit boards 20, for example by locating each closer to an integrated circuit that uses information communicated by pairs of optical transmitters 30 and optical receivers 40, thereby improving performance by reducing wire or waveguide 66 length. Note that wires or waveguides 66 indicated in the Figures can represent multiple independent or separate wires or waveguides 66 (e.g., a wire or waveguide bus 62).

In some embodiments, pairs of optical transmitters 30 and/or optical receivers 40 can be associated with one or a group of integrated circuits, for example so that each integrated circuit or group of integrated circuits can have a dedicated optical communication bus. Optical transmitters 30 or optical receivers 40 can be disposed adjacent to, on, or over an integrated circuit or module (e.g., having a separate module substrate).

In some embodiments and as illustrated in FIG. 1D, separate and different optical transmitters 30 can operate independently of each other, for example emitting light 70 at unrelated times and are not controlled with matrix addressing. Optical transmitters 30 can be separately and independently controlled to emit light 70 through a separate and independent wire 66 by receiver controller 50R. Similarly, separate and different optical receivers 40 can operate independently of each other, for example receiving light 70 at unrelated times. Each optical receiver 40 can be separately and independently controlled to receive light 70 through a separate and independent wire 66 by receiver controller 50R.

According to some embodiments of the present disclosure and as illustrated in FIG. 2A, FIG. 2B, and FIG. 2C, a circuit board 20 in a data-center communication system 10 can comprise both optical transmitters 30 and optical receivers 40 so that circuit board 20 can both transmit and receive optically encoded information in a bidirectional communication with other, similar circuit boards 20, for example adjacent circuit boards 20 in a stack. Specifically, in first circuit board 20A, optical transmitter 30 can be a first optical transmitter 30A, optical receiver 40 can be a first optical receiver 40A, and light 70 can be first light 70A. Second circuit board 20B can comprise a second optical transmitter 30B disposed on second circuit board 20B operable to emit second light 70B from second circuit board 20B to first circuit board 20A. First circuit board 20A can comprise a second optical receiver 40B disposed on first circuit board 20A operable to receive second light 70B. Thus, first circuit board 20A can send and receive light 70 with encoded information to and from second circuit board 20B. Similarly, second circuit board 20B can send and receive light 70 with encoded information to and from first circuit board 20A. First and second circuit boards 20A, 20B can therefore engage in bidirectional communication under the control of transmitter/receiver controllers 50 in combination with processor/storage and/or communication circuits 60. FIG. 2C illustrates the use of an optional optical system 26, for example one or more lenses or other optical elements that focus light 70 emitted by optical transmitters 30 onto optical receivers 40. Optical system 26 can be disposed between circuit boards 20 or can be disposed on or closely adjacent to optical transmitters 30 or optical receivers 40 (e.g., as lenslets, as shown in FIG. 2B). However, in some embodiments of the present disclosure, at least some of the light path between circuit boards 20 is free space (e.g., an atmosphere or vacuum).

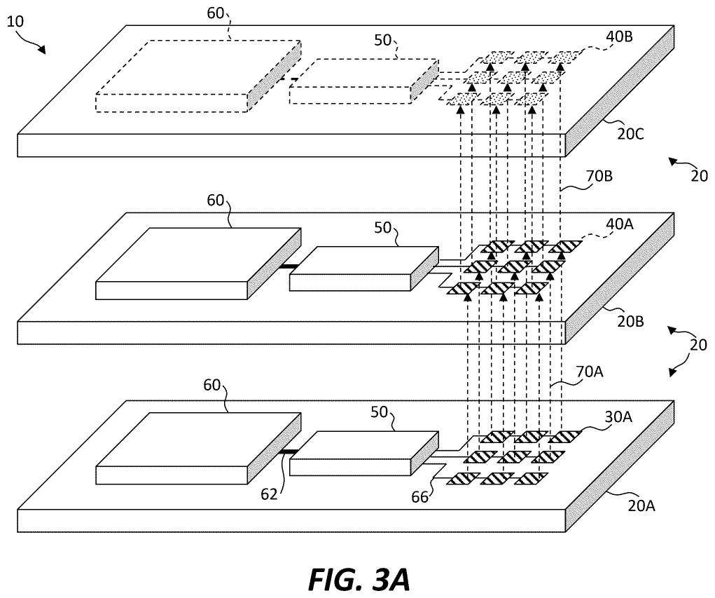

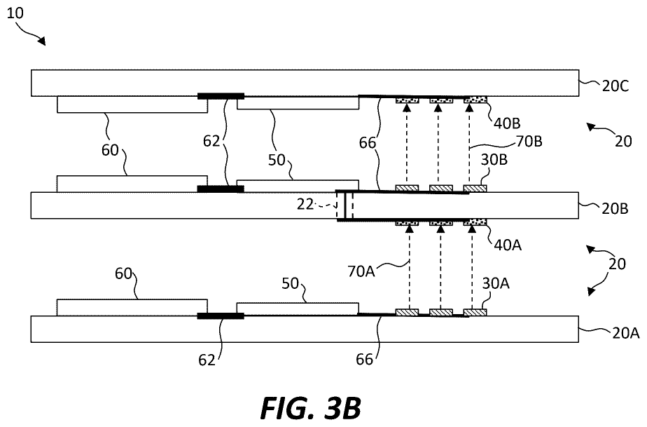

In some embodiments of the present disclosure and as illustrated in FIGS. 3A-3B, in some embodiments, data-center communication system 10 comprises more than two circuit boards 20. In some embodiments, emitted light 70 can pass from a first circuit board 20A to another, adjacent second circuit board 20B, pass through second circuit board 20B (for example through a hole in second circuit board 20B or pass through an at least partially transparent portion of second circuit board 20B), to a third circuit board 20C (discussed further below). As used herein, transparent means substantially transparent, for example no less than 50%, 60%, 70%, 80%, 90%, or 95% transparent to light 70 emitted by optical transmitters 30 or light 70 received or captured by optical receivers 40. Substantially transparent materials can comprise glass or plastic. In some such embodiments, optical receiver 40 can be disposed on a surface (e.g., circuit-board substrate 21) of a circuit board 20 (e.g., second circuit board 20B) adjacent to another circuit board 20 (e.g., first circuit board 20A). Similarly, optical transmitter 30 can be disposed on a surface (e.g., circuit-board substrate 21) of a circuit board 20 (e.g., first circuit board 20A) adjacent to another circuit board 20 (e.g., second circuit board 20B). Adjacent circuit boards 20 are circuit boards 20 between which no other circuit board 20 is present in a direction, the direction of a stack of circuit boards 20. Adjacent surfaces (e.g., a surface of circuit-board substrate 21) are those between which no other circuit-board substrate 21 surface is present.

In embodiments, data-center communication system 10 can comprise more than two circuit boards 20, for example three, four, five, or six circuit boards 20, or a larger number of circuit boards 20 and as many circuit boards 20 as can be assembled into a common rack 80. The more than two circuit boards 20 can all communicate using arrays 30R, 40R, respectively, of optical transmitters 30 and optical receivers 40 on each circuit board 20. As shown in the perspective of FIG. 3A and corresponding cross section of FIG. 3B, three circuit boards 20 (e.g., first, second, and third circuit boards 20A, 20B, 20C) are disposed in a fixed, stacked configuration with second circuit board 20B disposed between first circuit board 20A and third circuit board 20C in a rack 80 (shown in FIG. 1C).

In some embodiments, at least second circuit board 20B has one or more first optical receivers 40A on a side of second circuit board 20B facing first circuit board 20A and one or more second optical transmitters 30B on a side of second circuit board 20B facing third circuit board 20C and opposing the side of second circuit board 20B facing first circuit board 20A. First light 70A emitted from first optical transmitters 30A on first circuit board 20A is captured by first optical receivers 40A on second circuit board 20B and detected (and optionally processed) by transmitter/receiver controller 50 on second circuit board 20B, and then re-emitted from second optical transmitters 30B on second circuit board 20B toward second optical receivers 40B on third circuit board 20C as second light 70B. Hence, first optical receivers 40A and second optical transmitters 30B on second circuit board 20B serve to repeat optical signals 70 (e.g., first light 70A) from first circuit board 20A to third circuit board 20C with second light 70B in a same direction. Second circuit board 20B is therefore a repeater circuit board 20. Thus, first optical transmitter 30A disposed on first circuit board 20A can be a first optical transmitter 30A and embodiments can comprise a second optical transmitter 30B disposed on second circuit board 20B operable to emit second light 70B from second circuit board 20B to third circuit board 20C. First light 70A emitted from first circuit board 20A to second circuit board 20B can be an optical signal 70A and second light 70B emitted from second circuit board 20B to third circuit board 20C can transmit substantially the same optical signal 70B as 70A (or a different or modified optical signal 70B, e.g., comprising at least some common information). Such embodiments can provide optical buses, point-to-point optical communication, or both between circuit boards 20 in a rack 80 without the use of complex optical structures, such as splitters, optics for redirecting light 70 signals, or light detectors that detect light transmitted in a direction horizontal to a surface of a circuit board 20 (e.g., a surface on which are mounted optical receivers 40 such as photodiodes). Where repeater circuit boards 20 are used, optical structures in circuit-board substrates 21 such as holes or light-transmissive (transparent) portions can be unnecessary, simplifying construction and reducing costs.

Therefore, in some embodiments of the present disclosure, a data-center communication system 10 can comprise a first circuit board 20A comprising a first optical transmitter 30A operable to emit first light 70A, a second circuit board 20B comprising a first optical receiver 40A operable to receive first light 70A and a second optical transmitter 30B operable to emit second light 70B, and a third circuit board 20C comprising a second optical receiver 40B operable to receive second light 70B. First light 70A and second light 70B can propagate in a common direction. First circuit board 20A, second circuit board 20B, and third circuit board 20C can be disposed in a fixed spatial relationship. First circuit board 20A can be adjacent to second circuit board 20B, and second circuit board 20B can be adjacent to third circuit board 20C. First and third circuit boards 20A, 20C can be physically and spatially separated by second circuit board 20B in a direction, e.g., in a stack in rack 80. First and second light 70A and 70B can be modulated light 70 encoding information. Second circuit board 20B can be operable to decode received first light 70A from first circuit board 20A to extract the information and modulate second light 70B with at least some of the information. Embodiments can comprise a repeating optical bus in which information provided by first circuit board 20A is optically transmitted to second circuit board 20B and second circuit board 20B can optically transmit at least some of the information to third circuit board 20C to re-transmit the at least some of the information to third circuit board 20C, repeating information received from first circuit board 20A by transmitting the received information to third circuit board 20C.

Correspondingly, a data-center communication system 10 can comprise a first circuit board 20A comprising a first optical transmitter 30A operable to emit first light 70A and a second optical receiver 40B operable to receive second light 70B, a second circuit board 20B comprising a first optical receiver 40A operable to receive first light 70A and a second optical transmitter 30B operable to emit second light 70B. First circuit board 20A and second circuit board 20B can be adjacent and disposed in a fixed spatial relationship in a rack 80. First light 70A and second light 70B can each be modulated light 70 encoding information. First circuit board 20A can be operable to decode received second light 70B from second circuit board 20B to extract the information and modulate first light 70A with at least some of the information to re-transmit the at least some of the information to second circuit board 20B. Some embodiments of a data-center communication system 10 can comprise a reflecting optical bus in which at least some information optically transmitted by second circuit board 20B to first circuit board 20A is optically transmitted from second circuit board 20B back to first circuit board 20A.

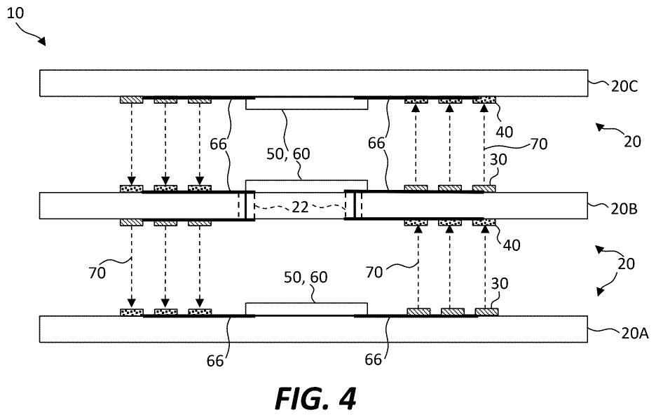

Although FIGS. 3A, 3B show only one repeater circuit board 20, in embodiments any number of repeater circuit boards 20 can be stacked in a fixed spatial relationship by rack 80 (shown in FIG. 1C with two circuit boards 20) between a top circuit board 20 (e.g., third circuit board 20C in FIG. 3B) and a bottom circuit board 20 (e.g., first circuit board 20A in FIG. 3B) in the stack. Since optical signals 70 are available on every circuit board 20 in the stack, the transmitted and received optical signals 70 form a one-way optical bus. FIG. 4 illustrates embodiments in which optical signals are transmitted in both directions (e.g., bidirectionally between circuit boards 20 in a stack or between adjacent circuit boards 20 in the stack) using two sets each of optical transmitters 30 and optical receivers 40 on second circuit board 20B. One set of optical transmitters 30 and optical receivers 40 repeats optical signals in a direction from bottom circuit board 20 (e.g., first circuit board 20A) to top circuit board 20 (e.g., third circuit board 20C) and the other set of optical transmitters 30 and optical receivers 40 repeats optical signals 70 in a direction from top circuit board (e.g., third circuit board 20C in FIG. 3B) to bottom circuit board 20 (e.g., first circuit board 20A). Top and bottom circuit boards 20 can also repeat optical signals 70, but in this case reflect optical signals 70 in an opposite direction toward other circuit boards 20 in the stack (e.g., top and bottom circuit boards 20 receive optical signals from a side of top and bottom circuit boards 20 and transmit optical signals 70 back in the opposite direction—the direction from which optical signals 70 came, forming a repeater circuit board 20 that is a reflector circuit board 20). Thus, data-center communication system 10 can implement a circulating and at least partially free-space optical bus from bottom reflector circuit board 20, through any number of intermediate repeater circuit boards 20, to a top reflector circuit board 20, and then back again from top reflector circuit board 20 to bottom reflector circuit board 20. The receipt and transmission of optical signals 70 can be controlled by transmitter/receiver controller 50 and the communicated information can be processed or produced by processor/storage circuits 60 on each circuit board 20.

Thus, in embodiments of the present disclosure, a repeater circuit board 20 can comprise a circuit-board substrate 21 with a surface, one or more processing, storage, or communication circuits (e.g., 50, 60) disposed on the surface, an optical transmitter 30 disposed on circuit-board substrate 21 and operable to emit light 70 in a first direction at least partially orthogonal to the surface, and an optical receiver 40 disposed on circuit-board substrate 21 and operable to receive light 70 from a second direction. The second direction can be at least partially or substantially the same as the first direction, e.g., the directions can be the same. In embodiments, the direction is substantially orthogonal to the surface, e.g., the surface on which the one or more processing, storage, or communication circuits (e.g., 50, 60) are disposed, for example within manufacturing constraints.

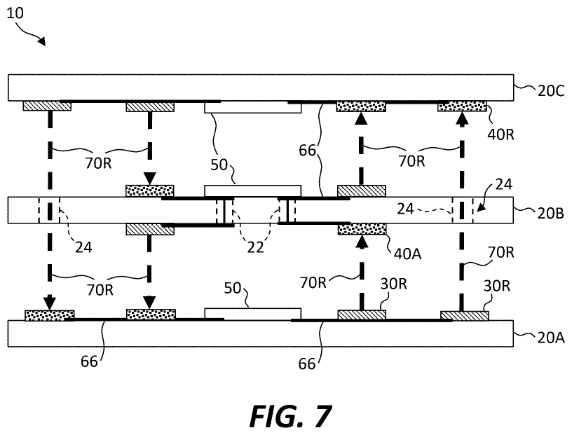

In some embodiments, a reflector circuit board 20 can comprise a circuit-board substrate 21 with a surface, one or more processing, storage, or communication circuits (e.g., 50, 60) disposed on the surface, an optical transmitter 30 disposed on circuit-board substrate 21 and operable to emit light 70 in a first direction at least partially orthogonal to the surface, and an optical receiver 40 disposed on circuit-board substrate 21 and operable to receive light 70 from a second direction. The second direction can be at least partially or substantially opposite the first direction, e.g., the directions can be in 180 degrees opposite directions. In embodiments, the direction is substantially orthogonal to a surface, e.g., the surface on which the one or more processing, storage, or communication circuits (e.g., 50, 60) are disposed, for example within manufacturing constraints. Light 70 can travel at least partially in free space to another circuit board 20. Optical transmitter 30 can be part of an array 30R of optical transmitters 30 and optical receiver 40 can be a part of an array 40R of optical receivers 40. Optical transmitter 30 and optical receiver 40 can be disposed on a common surface or side of circuit-board substrate 21 or on opposite sides, for example as are both shown in FIGS. 4 and 7.

In embodiments, an optical transmitter 30 and optical receiver 40 in a fixed spatial relationship on different circuit boards 20 can form a pair of transmit/receive pairs and different transmit/receive pairs can be disposed in unrelated locations on their respective circuit boards 20. As shown in FIG. 4, transmit/receive pairs of optical transmitters 30 and optical receivers 40 on each circuit board 20 in a stack of circuit boards 20 can form a circulating at least partially free-space optical bus. Thus, embodiments of the present disclosure can include a data-center communication system 10 comprising a stack of circuit boards 20 disposed in a rack 80. The stack of circuit boards 20 can comprise a top circuit board 20 disposed at the top of the stack that is a reflector circuit board 20, a bottom circuit board 20 disposed at the bottom of the stack that is a reflector circuit board 20, and repeater circuit boards 20 disposed between the top circuit board 20 and the bottom circuit board 20 in the stack. Repeater circuit boards 20 can comprise optical receivers 40 operable to optically receive information from an adjacent repeater circuit board 20 on a first side of the repeater circuit board 20 and optical transmitters 30 operable to transmit at least some of the received information to an adjacent repeater circuit board 20 on a second side of the repeater circuit board 20 opposite the first side. The top and bottom reflector circuit boards 20 can comprise optical receivers 40 operable to optically receive information from an adjacent repeater circuit board 20 and optical transmitters 30 operable to transmit at least some of the received information back to the adjacent repeater circuit board 20.

Optical communication between circuit boards 20 in the stack can be bidirectional. Thus, for the repeater circuit boards 20, the optical transmitters 30 are first optical transmitters 30, the optical receivers 40 are first optical receivers 40A, some embodiments can comprise second optical transmitters 30 that are operable to optically transmit information to an adjacent repeater circuit board 20 on the first side of repeater circuit board 20 and second optical receivers 40B operable to optically receive information from an adjacent repeater circuit board 20 on the second side of repeater circuit board 20. A first repeater circuit board 20 can be disposed adjacent to a second repeater circuit board 20 in the stack. Optical receivers 40 on first repeater circuit board 20 can be disposed in a first receiver location, optical transmitters 30 on first repeater circuit board 20 can be disposed in a first transmitter location, optical receivers 40 on second repeater circuit board 20 can be disposed in a second receiver location, optical transmitters 30 on second repeater circuit board 20 can be disposed in a second transmitter location. The first transmitter location of first repeater circuit board 20 can correspond to the second receiver location of second repeater circuit board 20. The first receiver location of first repeater circuit board 20 can correspond to the second transmitter location of second repeater circuit board 20.

In some embodiments, a third repeater circuit board 20 can be disposed adjacent to second repeater circuit board 20 in the stack, optical receivers 40 on third repeater circuit board 20 can be disposed in a third receiver location, optical transmitters 30 on third repeater circuit board 20 are disposed in a third transmitter location, and the first receiver location of first repeater circuit board 20 can correspond to the third transmitter location of third repeater circuit board 20 and the first transmitter location of first repeater circuit board 20 can correspond to the third receiver location of third repeater circuit board 20. A location that corresponds is meant that the relative location on a circuit board 20 in the stack is the same, e.g., the location or position on each circuit board 20 can be the same.

In some embodiments of the present disclosure, top circuit board 20 and bottom circuit board 20 in a stack are not reflective circuit boards 20, especially where repeater circuit boards 20 between top circuit board 20 and bottom circuit board 20 transmit optical information bidirectionally, since any information can be transmitted to another circuit board 20 in the stack without using a reflector circuit board 20 by selecting a direction of optical information transmission in the direction of the destination circuit board 20 in the stack.

Embodiments of the present disclosure illustrated in FIG. 3A to FIG. 4 dispose optical transmitters 30 and optical receivers 40 on opposite sides of a circuit-board substrate 21 of a repeater circuit board 20. Such printed-circuit boards or substrates can be constructed using methods known in the art and can use electrical vias 22 that conduct a wire 66 from one side of circuit-board substrate 21 to the other. In such embodiments, circuit-board substrate 21 need not be transparent and can comprise any useful substrate materials that can be processed to form electrical wires or waveguides 66 and wire or waveguide buses 62 and support optical transmitters 30, optical receivers 40, and any desired integrated circuits on each side of circuit-board substrate 21.

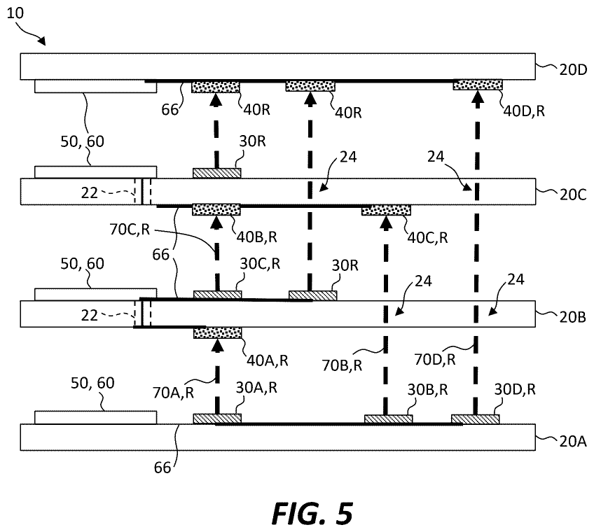

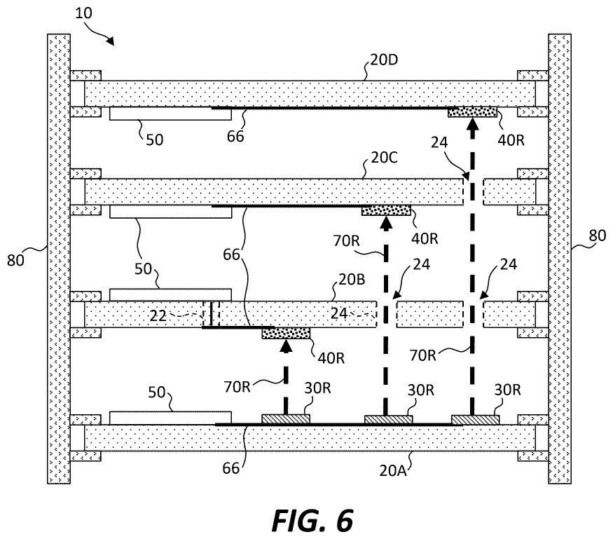

In some other embodiments and as illustrated in FIG. 5 and FIG. 6, light 70 can pass through circuit-board substrate 21. As shown in FIG. 5, at least some portion of circuit-board substrate 21 is transparent (e.g., an optical via 24) to allow optical signals 70 (light 70) to propagate through circuit-board substrate 21. Only the portions of circuit-board substrate 21 that pass light 70 need be transparent to light 70 emitted by optical transmitters 30. As shown in FIG. 6, at least some portion of circuit-board substrate 21 includes a hole (instead of a transparent material) to form an optical via 24 and allow optical signals 70 (light 70) to pass through circuit-board substrate 21. In some such embodiments, each circuit board 20 in the stack of circuit boards 20 can provide point-to-point optical communication from each circuit board 20 to another circuit board 20. Adjacent circuit boards 20 can optically communicate as illustrated in FIG. 1A, circuit boards 20 that are separated by other circuit boards 20 can comprise optical vias 24 in each intervening circuit board 20 for each communication channel desired.

FIG. 5 shows the optical communication paths for communicating in a direction from first circuit board 20A to fourth circuit board 20D. In embodiments, first to fourth circuit boards 20A to 20D also include optical transmitters 30 (e.g., optical transmitters 30A, 30B, 30C, 30D) and optical receivers 40 (e.g., optical receivers 40A, 40B, 40C 40D) to enable optical communication in a direction from first circuit board 20A to fourth circuit board 20D. FIG. 6 illustrates only optical vias 24 enabling point-to-point optical communication from bottom first circuit board 20A to top fourth circuit board 20D. In a more complete embodiment (e.g., as shown in FIG. 7 for a smaller stack), optical vias 24 can be provided for each direct communication between any two circuit boards 20 in a stack, as needed, enabling bidirectional point-to-point optical communication between circuit boards 20 in a stack of circuit boards 20 in a rack 80. In such embodiments, point-to-point optical communication between a stack of circuit boards 20 in a rack 80 is also board-to-board optical communication, e.g., each board is a “point”.

FIG. 7 illustrates bidirectional point-to-point optical communication for a stack comprising three circuit boards 20 in which center circuit boards 20 are between top circuit board 20 and bottom circuit board 20. Top and bottom are relative terms that can be exchanged. Thus, in embodiments of the present disclosure, a transparent circuit board 20 can have a circuit-board substrate 21 portion at least partially transparent to light 70 emitted by optical transmitters 30 on a different circuit board 20, for example comprising an at least partially transparent material in circuit board 20 or comprising a hole through which emitted light 70 passes from a circuit board 20 beneath transparent circuit board 20 to a circuit board 20 above transparent circuit board 20 (where below means closer to a bottom circuit board 20 in a stack of circuit boards 20 and above means closer to a top circuit board 20 in the stack of circuit boards 20). Above and below are relative terms that can be exchanged. For clarity, in FIG. 5 and FIG. 6, arrays 30R, 40R, 70R of optical transmitters 30, optical receivers 40, and light 70 rays are illustrated with only a single one of each of those elements. Thus, in embodiments, a data-center communication system 10 can comprise a circuit board 20 (e.g., third circuit board 20C) and (i) an optical receiver 40 disposed on third circuit board 20C disposed to receive light 70 from first circuit board 20A, (ii) an optical transmitter 30 disposed on third circuit board 20C disposed to transmit light 70 to first circuit board 20A, or (iii) both (i) and (ii).

Some embodiments of the present disclosure can provide increased system bandwidth for optical data communication by providing point-to-point (board-to-board) communication between circuit boards 20 in a stack so that each circuit board 20 can communicate directly to other circuit boards 20 in the stack, including between circuit boards 20 that are not adjacent in the stack. In some such embodiments, a data-center communication system 10 can comprise a first circuit board 20A comprising a first optical transmitter 30 operable to emit first light 70A and a second optical transmitter 30 operable to emit second light 70B different from first light 70A, a second circuit board 20B comprising a first optical receiver 40A operable to receive first light 70A and a third optical transmitter 30 operable to emit third light 70C different from first light 70A and different from second light 70B, a third circuit board 20C comprising a second optical receiver 40B operable to receive second light 70B and a third optical receiver 40C operable to receive third light 70C. First circuit board 20A, second circuit board 20B, and third circuit board 20C can be disposed in a fixed and aligned spatial relationship, light 70 can be modulated light 70 encoding information, and second circuit board 20B can comprise a hole or at least has a transparent portion through which third light 70C passes undetected.

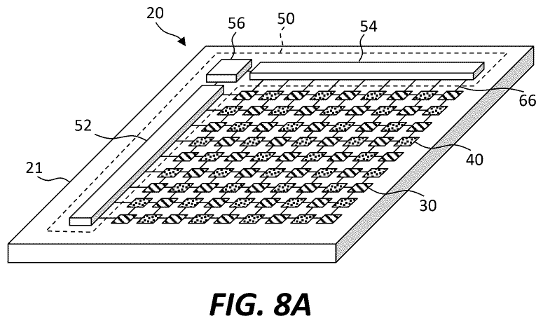

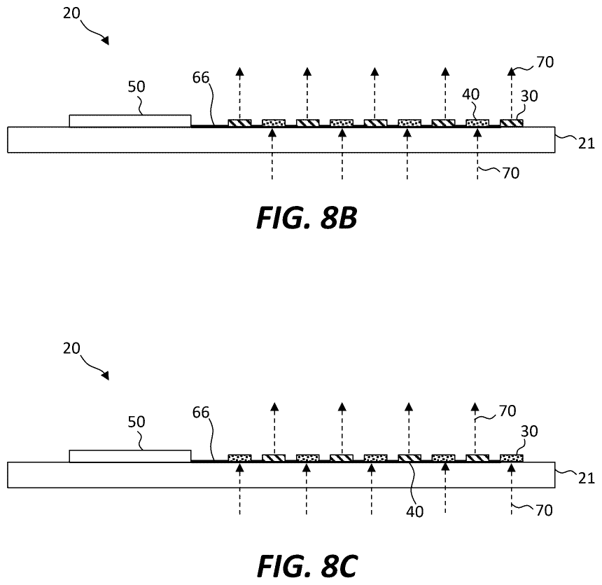

Optical transmitters 30 and optical receivers 40 can be disposed on opposite sides of circuit-board substrate 21, for example as shown in FIG. 7, and electrically connected to transmitter/receiver 50 through electrical vias 22. In this way, optical transmitters 30 and optical receivers 40 can occupy the same area on opposite sides of circuit-board substrate 21 (in a direction orthogonal to a surface of circuit-board substrate 21). In some embodiments of the present disclosure, optical transmitters 30 and optical receivers 40 can be disposed on a same side of circuit-board substrate 21 and can be interdigitated or interspersed on the same side so that optical transmitters 30 and optical receivers 40 can be disposed in different areas or locations of the same side of circuit-board substrate 21. FIG. 8A illustrates such an embodiment with optical transmitters 30 and optical receivers 40 disposed in an array 30R, 40R and alternatingly interdigitated in every row and every column to form a checkerboard pattern. However, in embodiments of the present disclosure optical transmitters 30 and optical receivers 40 can be disposed in any arrangement on a common side of circuit-board substrate 21 for example in alternating rows and columns. Thus, in some embodiments, each of optical receivers 40 disposed on second circuit board 20B can be disposed to receive light 70 from a corresponding one of optical transmitters 30 disposed on first circuit board 20A. To enable multiple repeater circuit boards 20 in a stack of circuit boards 20 in rack 80, as shown in FIGS. 8B and 8C, alternating circuit boards 20 in the stack can have a layer of alternating locations of optical transmitters 30 and optical receivers 40 so that light 70 emitted by optical transmitters 30 on one circuit board 20 (e.g., circuit board 20 in FIG. 8B) can be directly received (e.g., in an orthogonal direction) by optical receivers 40 on a different adjacent circuit board 20 (e.g., circuit board 20 in FIG. 8C) and vice versa. Thus, the layout of optical transmitters 30 and optical receivers 40 can alternate on alternating repeater circuit boards 20 in a stack. In embodiments comprising repeater circuit boards 20 with optical transmitters 30 on one side and optical receivers 40 on an opposite side, the locations of optical transmitters 30 on the one side of repeater circuit board 20 can match or correspond to the locations of optical receivers 40 on the side opposing the one side (e.g., the opposite side of repeater circuit board 20). Thus, optical transmitters 30 and optical receivers 40 can directly (e.g., orthogonally) emit and receive light 70 in a stack of circuit boards 20, simplifying the optical structure of data-center communication system 10.

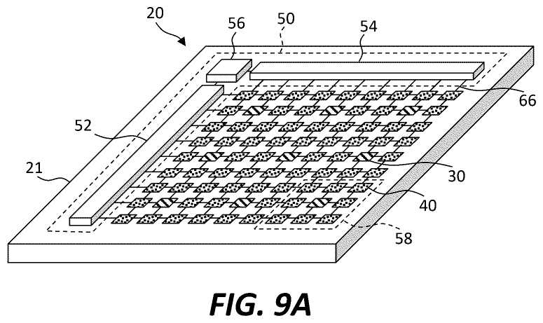

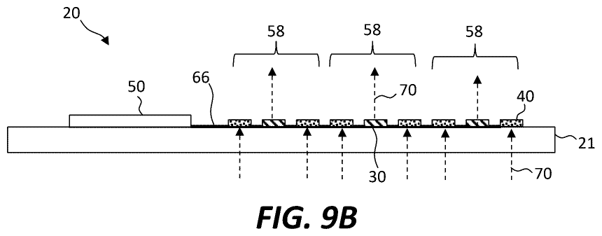

FIG. 8A illustrates embodiments in which optical transmitters 30 and optical receivers 40 are disposed in arrays 30R, 40R electrically connected in rows and columns with wires or waveguides 66 to a row controller 52 operable to select rows and a column controller 54 operable to provide or receive rows of data to selected rows under the control of an array controller 56. Row controller 52, column controller 54, and array controller 56 comprise a transmitter/receiver controller 50 and provide matrix control to optical transmitters 30 and optical receivers 40, so that rows of optical transmitters 30 or optical receivers 40 (or both) can be updated with data one row at a time and no row is updated again until all of the other rows are updated in a frame at a frame rate (also shown in FIG. 9A). In some embodiments either or both of optical transmitters 30 and optical receivers 40 are directly electrically connected to and independently controlled by transmitter/receiver controller 50 without the use of matrix addressing. In such directly controlled embodiments, optical transmitters 30 and optical receivers 40 can operate independently and can be updated without reference to updating any other optical transmitters 30 and optical receivers 40 with data (e.g., as in FIG. 1D). (To update means to provide data for emission by optical transmitters 30 or to receive data from optical receivers 40.)

In some embodiments, the number of optical receivers 40 can be greater than the number of optical transmitters 30. Thus, multiple optical receivers 40 can capture light 70 from a single optical transmitter 30 forming an exclusive group 58 (e.g., a subset) of optical transmitters 30 and optical receivers 40. As shown in the perspective of FIG. 9A and cross section of FIG. 9B, each optical transmitter 30 can be surrounded by optical receivers 40 and can receive or capture light 70 from a single optical transmitter 30 on another circuit board 20. Thus, in some embodiments, an exclusive subset of optical receivers 40 disposed on a second circuit board 20B is disposed to receive light 70 from a corresponding one of optical transmitters 30 disposed on a first circuit board 20A. This enables optical receivers 40 to receive light 70 that spreads out over an area over the optical receiver 40 substrate with multiple optical receivers 40 and improve a signal-to-noise ratio for the received optical signal 70. In some embodiments, optical receivers 40 are a different size or have a different area over circuit-board substrate 21. In general, any useful arrangement of optical transmitters 30 and optical receivers 40 of any sizes or numbers can be used in embodiments of the present disclosure.

Thus, in embodiments of the present disclosure, a data-center communication system 10 can comprise a first circuit board 20A comprising an optical transmitter 30 operable to emit light 70, a second circuit board 20B comprising multiple optical receivers 40 operable to receive light 70 emitted from optical transmitter 30 so that multiple optical receivers 40 are disposed to receive light 70 from a single optical transmitter 30. First circuit board 20A and second circuit board 20B can be disposed in a fixed spatial relationship. Such an arrangement of optical transmitter 30 and optical receivers 40 can improve signal to noise by using redundant optical receivers 40 whose signals can be combined and can relax the requirements for directional light emission from optical transmitter 30, enabling easier and simple construction of both optical transmitter 30 and the relative alignment of circuit boards 20 in a stack in rack 80.

Some embodiments comprise multiple optical transmitters 30 operable to emit light 70 disposed on first circuit board 20A and multiple optical receivers 40 operable to receive light 70 from each optical transmitter 30 disposed on second circuit board 20B. In some embodiments, multiple optical receivers 40 are operable to receive light 70 from one of optical transmitters 30 and are disposed adjacent to each other on second circuit board 20B. Some embodiments comprise optical transmitters 30 disposed on second circuit board 20B. Multiple optical receivers 40 operable to receive light 70 from one of optical transmitters 30 on first circuit board 20A can be disposed adjacent to an optical transmitter 30 on second circuit board 20B. The optical transmitters 30 on or over a surface of second circuit board 20B can be interdigitated with optical receivers 40 on or over the surface in a direction horizontal to the surface. The interdigitation can be in a two-dimensional checkerboard arrangement, in alternating rows, or in alternating columns. In some embodiments, optical receivers 40 can surround optical transmitters 30 on or over the surface in one or two dimensions on second circuit board 20B.

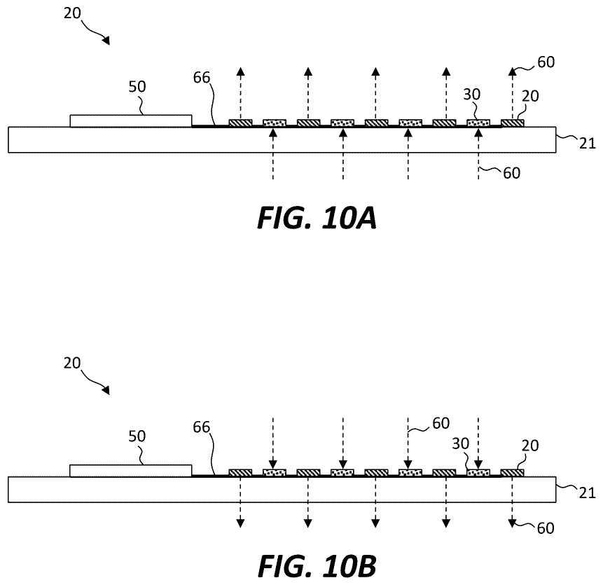

In some embodiments of the present disclosure, optical receivers 40 can receive light 70 through circuit-board substrate 21 and optical transmitters 30 can emit light 70 through circuit-board substrate 21, as shown in FIG. 10A. In some embodiments, optical transmitters 30 can emit light 70 through circuit-board substrate 21 and optical receivers 40 can receive light 70 through circuit-board substrate 21, as shown in FIG. 10B.

In some embodiments, optical transmitters 30 and optical receivers 40 can be disposed on a common side or surface of a circuit board 20 and circuit board 20 can be at least partially or substantially (e.g., no less than 50%, 60%, 70%, 80%, 90%, or 95%) transparent to light 70 emitted by optical transmitters 30 or light 70 received by optical receivers 40. In embodiments, a circuit board 20 for optical communication can comprise a circuit-board substrate 21 having a surface, an optical transmitter 30 disposed on the surface operable to emit light 70 in a direction, and an optical receiver 40 disposed on the surface operable to receive light 70 from the same direction. Circuit-board substrate 21 can be at least partially transparent to light 70 emitted by optical transmitter 30 or received by optical receiver 40. In some embodiments, optical transmitter 30 can be disposed and operable to emit light 70 in a direction away from circuit-board substrate 21 and optical receiver 40 can be disposed and operable to receive light 70 through circuit-board substrate 21. In some embodiments, optical transmitter 30 can be disposed and operable to emit light 70 through circuit-board substrate 21 and optical receiver 40 can be disposed and operable to receive light 70 in a direction away from circuit-board substrate 21. In embodiments, optical transmitter 30 can be disposed adjacent to optical receiver 40 on the surface in a direction parallel to the surface.

In some embodiments of the present disclosure, all of optical transmitters 30 emit light 70 of the same frequency, e.g., within manufacturing tolerances. In other embodiments, optical transmitters 30 emit light 70 of different frequencies, for example various frequencies of infrared, red, yellow, green, cyan, blue, and ultraviolet. In embodiments, each optical transmitter 30 (or each of a group of optical transmitters 30) on a circuit-board substrate 21 emits light 70 of a different frequency. Optical receivers 40 can each respond to a corresponding different frequency emitted by optical transmitters 30, for example various frequencies of infrared, red, yellow, green, cyan, blue, and ultraviolet. Optical transmitters 30 can comprise different epitaxial materials (e.g., compound semiconductors such GaAs, GaN, InP) or different light conversion materials (for example ultraviolet light emitters together with phosphors or quantum dots that convert emitted light 70 to a corresponding desired frequency). Optical transmitters 30 can be micro-light-emitting diodes. Similarly, optical receivers 40 can comprise photosensors sensitive to desired frequencies, for example a photodiode together with a light filter for selecting a desired frequency.

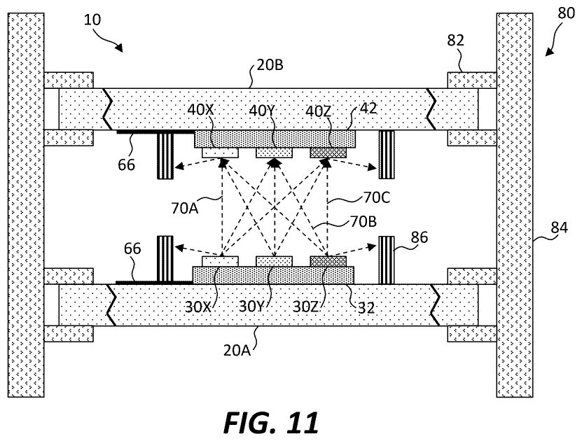

By emitting different colors (frequencies) of light 70 with optical transmitters 30, optical receivers 40 can select a corresponding frequency of light 70 and more than one, a subset or group 58 of, or all of optical receivers 40 on a circuit board 20 can be exposed to light 70 emitted by all of optical transmitters 30 on an adjacent circuit board 20. Thus, in some such embodiments, it is not necessary to direct light 70 emitted by each optical transmitter 30 to only a single optical receiver 40. As shown in FIG. 11, light 70 emitted from each optical transmitter 30 (e.g., 30X, 30Y, 30Z) on a circuit board 20 impinges on all of optical receivers 40 on an adjacent circuit board 20 in rack 80. Each optical receiver 40 (e.g., 40X, 40Y, 40Z) filters the impinging light 70 to provide an optical signal for a corresponding frequency. Therefore, and according to embodiments of the present disclosure, a data-center communication system 10 can comprise a first circuit board 20A comprising a first optical transmitter 30X operable to emit first light 70A of a first frequency (e.g., color) and a second optical transmitter 30Y operable to emit second light 70B of a second frequency (e.g., color) different from the first frequency and a second circuit board 20B comprising a first optical receiver 40X operable to receive first light 70A and a second optical receiver 40Y operable to receive second light 70B. In embodiments, first circuit board 20A can also comprise a third optical transmitter 30Z operable to emit third light 70C and second circuit board 20B can comprise a third optical receiver 40Z operable to receive third light 70C. Light 70 can be modulated light 70 encoding information, first circuit board 20A and second circuit board 20B can be disposed in a fixed spatial relationship, and first circuit board 20A and second circuit board 20B can be adjacent (nearest neighbor) circuit boards 20 between which there is no other circuit board 20, e.g., in a direction such as the direction of stack of circuit boards 20 in rack 80. Thus, alignment tolerances between circuit boards 20 in rack 80 are reduced because emitted light 70 need not be collimated (e.g., is uncollimated or non-collimated) and the multiple communication frequencies provide increased bandwidth between two adjacent circuit boards 20 in rack 80. Moreover, simpler light emitters (e.g., light-emitting diodes) can be used in place of more complex light emitters such as lasers (e.g., laser diodes or VCSELS) that can emit collimated light 70.

In some embodiments of the present disclosure, three, four, five or more optical transmitters 30 that each emit a different frequency or color of light 70 can be disposed on first circuit board 20A and a similar number of optical receivers 40 that each receive (absorb or respond to) the different frequencies or colors of light 70 can be disposed on second circuit board 20B. Moreover, different groups 58 of optical transmitters 30 and optical receivers 40 can be disposed on adjacent circuit boards 20 to provide bidirectional communication (e.g., as shown in FIG. 2A) or multiple, multi-frequency communication, where pairs of optical transmitters 30 and optical receivers 40 each communicate with a different frequency of light 70. Thus, bidirectional embodiments of the present disclosure can comprise a data-center communication system 10 in which second circuit board 20B comprises a third optical transmitter 30 operable to emit light 70 of the first frequency and a fourth optical transmitter 30 operable to emit light 70 of the second frequency and first circuit board 20A comprises a third optical receiver 40 operable to receive light 70 from third optical transmitter 30 and a fourth optical receiver 40 operable to receive light 70 from third optical transmitter 30. In some embodiments, light transmitted from first circuit board 20A to second circuit board 20B has a first frequency (or first set of frequencies) and light transmitted from second circuit board 20B to first circuit board 20A has a second frequency (or second set of frequencies) different from the first frequency (or first set of frequencies). Using different frequencies can reduce interference between the bidirectional communications.

In some embodiments, multi-frequency light 70 emitted from a first circuit board 20A is only received by an adjacent second circuit board 20B, e.g., as shown in FIGS. 11 and 1A. In other embodiments, adjacent circuit boards 20 each have multi-frequency groups 58 of optical (light) transmitters 30 and optical (light) receivers 40 to provide bidirectional communication, e.g., as shown in FIGS. 2A-2C. Some embodiments can comprise repeater circuit boards 20 (as shown in FIGS. 3A, 3B) or can comprise reflector circuit boards 20 (as shown in FIG. 4). In some embodiments, multi-frequency emitted light 70 can propagate through an adjacent circuit board 20 to a remote circuit board 20, e.g., as shown in FIGS. 5-7.

In embodiments comprising multi-frequency groups 58 of optical transmitters 30 and optical receivers 40, the communication bandwidth can be determined by the number of different frequencies and the data rate of each optical transmitter 30 and optical receiver 40 pair, multiplied by the number of optically separate groups 58 of multi-frequency pairs.

Stray emitted light 70 can be further reduced with the use of one or more light-absorbing walls 86, for example dielectric structures comprising light absorbing (e.g., black) material that extend from circuit-board substrate 21 surface and that absorb emitted or external environmental light. If light-absorbing walls 86 are sufficiently tall, multiple groups 58 of multi-frequency optical transmitters 30 can be disposed on a circuit board 20 in approximate alignment with optical receivers 40 on an adjacent circuit board 20. Thus, in some embodiments of a data-center communication system 10, first circuit board 20A has a surface on which is disposed first optical transmitter 30A and second optical transmitter 30B and a light-absorbing wall 86 that extends from the surface toward second circuit board 20B (e.g., extends a distance no less than a height that first or second optical transmitter 30A, 30B extends from the surface, extends a distance greater than a height that first or second optical transmitter 30A, 30B extends from the surface, extends a distance no less than 1.5, two, three, or four times a height that the first or second optical transmitter 30A, 30B extends from the surface). Similarly, in some embodiments of a data-center communication system 10, second circuit board 20B has a surface on which is disposed first optical receiver 40A and second optical receiver 40B and a light-absorbing wall 86 that extends from the surface toward first circuit board 20A (e.g., extends a distance no less than a height that first or second optical receiver 40A, 40B extends from the surface, extends a distance greater than a height that first or second optical receiver 40A, 40B extends from the surface, extends a distance no less than 1.5, two, three, or four times height that the first or second optical receiver 40A, 40B extends from the surface).

FIG. 12 illustrates a generic micro-transfer printed integrated circuit, for example a micro-transfer-printed optical transmitter 30, optical receiver 40, transmitter/receiver controller 50, processor/storage circuit 60, input/output circuit 64, or any integrated circuit comprised in circuit board 20. Any one or combination of these can be micro-transfer printed from a source wafer to circuit-board substrate 21. As a consequence of micro-transfer printing, a micro-transfer printed integrated circuit can comprise a fractured (e.g., broken) or separated tether 92 and can be electrically connected to circuits on circuit-board substrate 21 with a thin-film interconnect comprising a patterned electrode 28 electrically connecting a contact pad 29 (e.g., an electrical terminal) on the micro-transfer printed integrated circuit to an electrical contact pad 29 on circuit-board substrate 21. Electrode 28 can be electrically insulated from the micro-transfer-printed integrated circuit (except for the terminal) by a patterned dielectric structure 27, especially if the micro-transfer-printed integrated circuit comprises a semiconductor substrate, to avoid undesired electrical currents in the substrate or circuits in the micro-transfer-printed integrated circuit. The circuits on circuit-board substrate 21 can electrically control or respond to the micro-transfer printed integrated circuit.

In some embodiments, one or more of optical transmitter 30, optical receiver 40, transmitter/receiver controller 50, processor/storage circuit 60, or input/output circuit 64 can be disposed on and non-native to circuit-board substrate 21 (e.g., by surface mount, pick-and-place, or micro-transfer printing techniques) or can be formed in or on and native to circuit-board substrate 21 using photolithographic methods and materials, for example where circuit-board substrate 21 (or transmitter substrate 32 or receiver substrate 42) is a semiconductor (e.g., a crystalline silicon substrate) and as shown in FIG. 12 with transmitter/receiver controller 50 and electrically connected using wires or waveguides 66 comprising photolithographically deposited and patterned conductive material such as metal or silicon nitride.

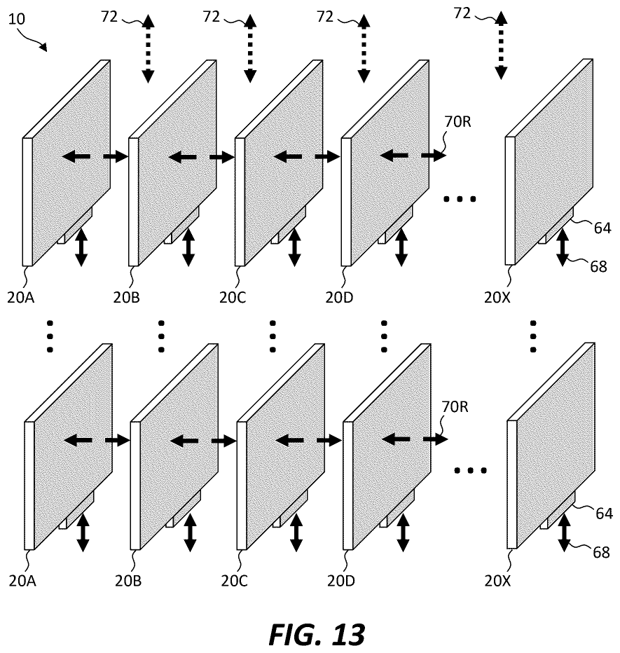

Circuit boards 20 can be disposed in a rack 80 holding each circuit board 20 in a fixed and aligned position with respect to other circuit boards 20 in rack 80. As shown in FIG. 13, data-center communication system 10 can comprise a rack 80 or multiple racks 80 each with multiple circuit boards 20 that intercommunicate with one or an array 70R of light beams 70. In some embodiments, communications between circuit boards 20 in a common rack 80 can be sent optically using one or more light beams 70 using optical transmitters 30 and optical receivers 40. Communications between circuit boards 20 in different racks 80 can be sent by other means, for example using input/output circuits 64 and optical fibers 68 or other means of inter-rack 80 communication. In embodiments, routers can be integrated into one or more circuit boards 20 to facilitate determining whether to use light beams 70 using optical transmitters 30 and optical receivers 40 or to use input/output circuits 64 and optical fibers 68. Routers can be provided in a single circuit board 20 in a rack 80, in multiple circuit boards 20 in a rack 80, or in every circuit board 20 in a rack 80, e.g., in integrated circuit 60 or transmitter/receiver controller 50.

In some embodiments, a chilled fluid 72, e.g., a chilled gas (such as air) or liquid (such as water), can be disposed to flow over and/or between circuit boards 20 (e.g., first, second, third, fourth circuit boards 20A, 20B, 20C, 20D and so on to circuit board 20X) in rack 80 (shown in FIG. 13). Chilled fluid 72 can cool the integrated circuit components on circuit boards 20 and thus allow them to operate faster and for a longer period of time. Multiple racks 80 of circuit boards 20 can be disposed adjacent to each other and chilled fluid 72 can flow (e.g., in a laminar fashion) between circuit boards 20 in racks 80. Racks 80 can support circuit boards 20 in a vertical or horizontal position, or any useful position, especially one that enables the flow of chilled fluid 72.

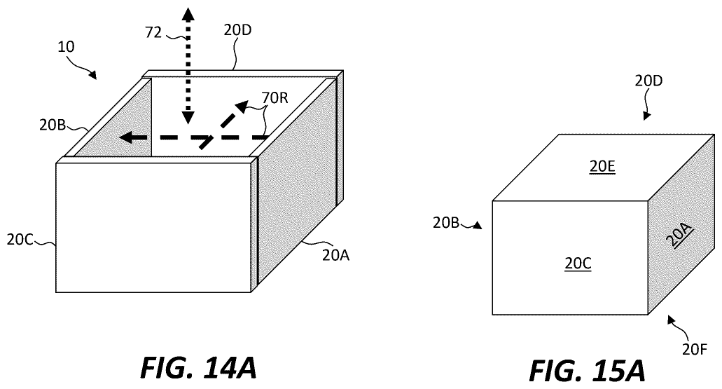

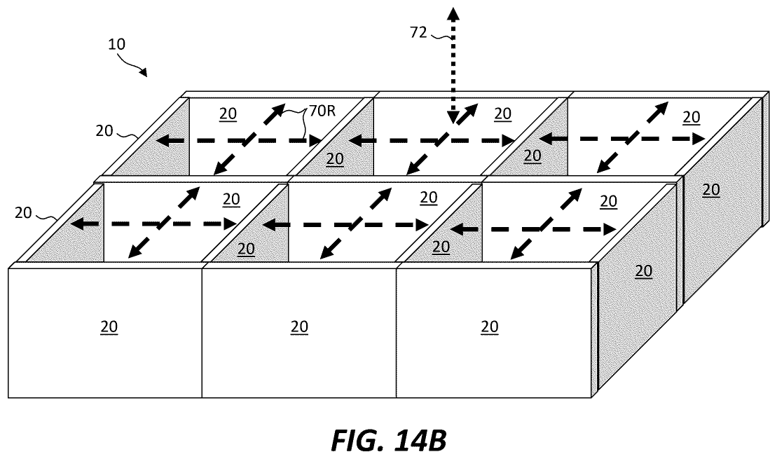

FIG. 13 illustrates circuit boards 20 arranged substantially parallel to each other in a rack 80. However, in other embodiments, circuit boards 20 can be arranged in other configurations. For example, and as shown in the embodiments of FIG. 14A, four circuit boards 20 (e.g., first, second, third, and fourth circuit boards 20A, 20B, 20C, 20D) can be arranged to form the sides of a cube. Adjoining circuit boards 20 can be electrically connected at the corners (e.g., first circuit board 20A to third and fourth circuit boards 20C and 20D, second circuit board 20B to third and fourth circuit boards 20C and 20D, third circuit board 20C to first and second circuit boards 20A and 20B, and fourth circuit board 20D to first and second circuit boards 20A and 20B), as shown, and circuit boards 20 on opposing sides of the square can optically communicate with arrays 70R of optical light beams 70 as described above (e.g., first circuit board 20A to second circuit board 20B, second circuit board 20B to first circuit board 20A, third circuit board 20C to fourth circuit board 20D, and fourth circuit board 20D to third circuit board 20C). Adjoining circuit boards 20 can communication electrically or optically through wave guides. Circuit boards 20 can also communicate externally through input/output circuits 64 and optical fiber 68 (not shown in FIG. 14A but shown in FIGS. 1A and 12). Chilled fluid 72 can be directed to flow through the center of the square of circuit boards 20 as well as around the exterior of the square. Multiple squares of circuit boards 20 (shown in FIG. 14B) can be mounted in a rack 80 (not shown). As shown in FIG. 14B, squares of circuit boards 20 can be integrated with circuit boards 20 shared between adjacent squares with chilled fluid 72 flowing through the squares. In embodiments, integrated circuits can be disposed on both sides of each circuit board 20, increasing the area available for processing or storage and enabling free-space optical communication between circuit boards 20 in each square, as shown in FIG. 14A. Circuit boards 20 forming parallel sides of the squares can be a stack of circuit boards 20, as discussed above, and the two orthogonal light beams 70 can pass through each other without interference. Thus, in embodiments of the present disclosure, configurations such as those of FIG. 14B can form two orthogonal and integrated stacks of circuit boards 20, forming a highly dense structure of circuit boards 20 with improved communication and cooling.

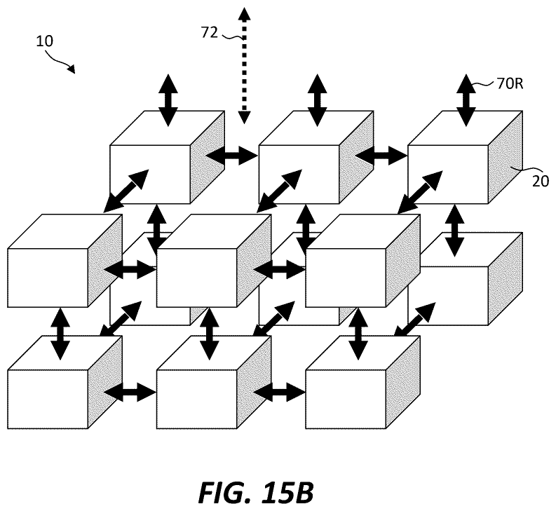

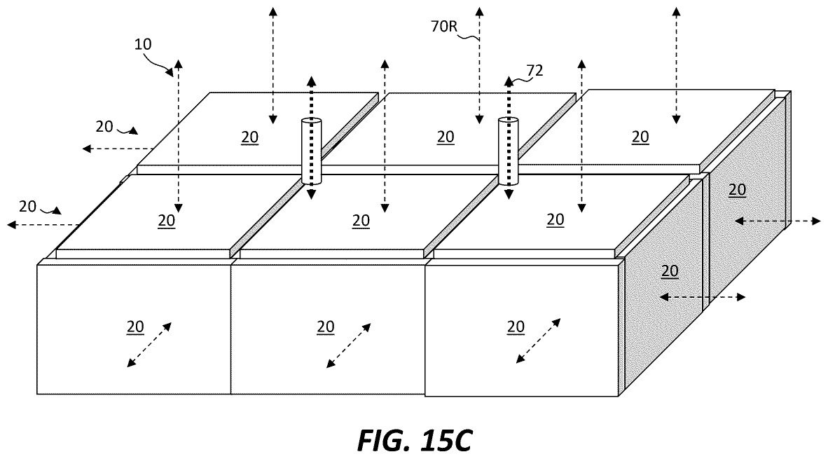

In some embodiments of the present disclosure and as shown in FIG. 15A, circuit boards 20 can be disposed in cubes having a circuit board 20 on each side of the cube. Circuit boards 20 on opposing interior sides of the cube can intercommunicate with arrays 70R of optical light beams 70 (not shown in FIG. 15A). The cubes of circuit boards 20 can be arranged in a three-dimensional array and adjacent circuit boards 20 in different cubes can also intercommunicate with arrays 70R of optical light beams 70, as shown in FIG. 15B. (For clarity, only some of the cubes of circuit boards 20 and arrays 70R of optical light beams 70 in the three-dimensional array of circuit boards 20 are shown in FIG. 15B.) Chilled fluid 72 can pass through the array of cubes of circuit boards 20 to provide cooling. Circuit boards 20 forming parallel sides of the cubes can be a stack of circuit boards 20, as discussed above, and the three bidirectional orthogonal light beams 70 can pass through each other without interference. Thus, in embodiments of the present disclosure, configurations such as those of FIG. 15B can form three orthogonal and integrated stacks of circuit boards 20, forming a highly dense structure of circuit boards 20 with improved communication and cooling. In some embodiments and as shown in FIG. 15C, adjacent cubes share circuit boards 20 (as in FIG. 14B). In such embodiments, chilled cooling fluids 72 can flow through circuit-board substrates 21 or one or more dimensions of circuit-board substrates 21 can comprise a hole (shown as a cylinder) through which chilled fluid 72 is conveyed.

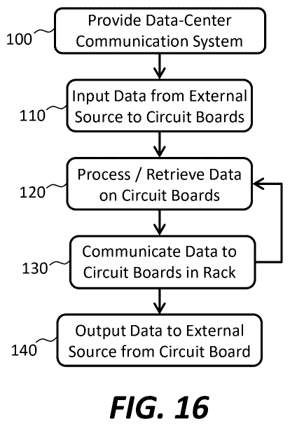

Embodiments of the present disclosure are applicable to a wide variety of data-center operations, including but not limited to processing tasks such as modeling, query interpretation, or AI training and data retrieval tasks such as accessing stored information. As shown in the FIG. 16 flow diagram, a data-center communication system 10 according to embodiments of the present disclosure is provided in step 100 and data is input to data-center communication system 10 from an external source such as a computer connected to the internet in step 110. Data-center communication system 10 can likewise be connected to the internet, e.g., through routers. The data can be any information pertinent to a data-center task. Data can be provided to one or more circuit boards 20 (e.g., through optical fiber 68 using input/output circuit 64). In particular multiple sets of data (multiple tasks) can be provided to one or more circuit boards 20 in data-center communication system 10 at a time. In step 120, the input data is processed or analyzed, and information retrieved by circuit boards 20 and, as necessary, data is communicated to and from other circuit boards 20 in rack 80 to access other data or provide additional circuit boards 20 for processing a task, as desired, in step 130. The steps of processing/retrieval (step 120) and communicating data (step 130) to other circuit boards 20 in rack 80 (or other racks 80 of circuit boards 20) using optical transmitters 30 and optical receiver 40 and also through input/output circuits 64 and optical fibers 68 can be repeated as necessary. When a task is completed, data can be output to the external source in step 140.

External communication from any circuit board 20 (e.g., through input/output circuit 64 and optical fiber 68) is limited, for example to data that can be transferred through a single fiber or a linear array of fibers 68. In contrast, in embodiments of the present disclosure, a two-dimensional array of micro-devices (e.g., optical transmitters 30 and optical receivers 40) can optically intercommunicate between circuit boards 20 in rack 80. The high-density communication structure enabled by embodiments of the present disclosure can greatly increase the communication bandwidth between circuit boards 20 in a rack 80. For example, the bandwidth of a single optical link through input/output circuit 64 and optical fiber 68 can be, for example 100 Gbps. Ten-by-ten arrays 30R, 40R of optical transmitters 30 and optical receivers 40, respectively, can transmit 100 times as much data (e.g., 10 Tbs), and multiples of such arrays 30R, 40R can further increase the bandwidth.

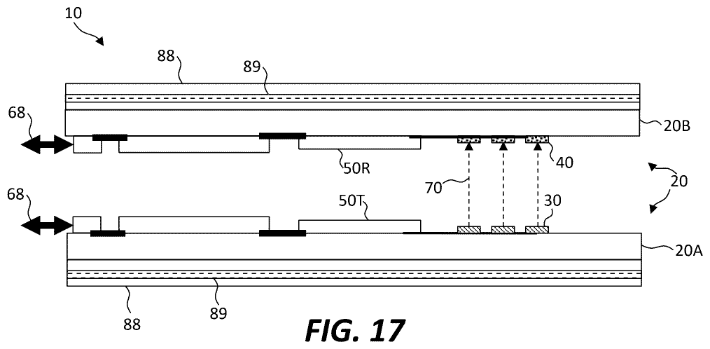

In some embodiments of the present disclosure, one or more cooling devices or structures, such as cooling block(s), can be integrated into data-center communication system 10. For example, and as shown in FIG. 17, a cooling block 88, for example comprising one or more channels 89 (e.g., one or more pipes) for conducting a chilled fluid 72 such as gas or liquid pumped through channels 89 in cooling block 88, can be disposed adjacent to or in contact with circuit boards 20. Cooling block 88 can comprise one or more other methods of cooling, for example one or more thermo-electric coolers or can contact an external cooling device. Cooling block 88 can comprise a metal (e.g., aluminum), ceramic, or glass, or other material suitable for conducting heat. Cooling block 88 can cool circuit boards 20 and any optical transmitters 30 or optical receivers 40 disposed therein to improve their operation. Cooling blocks 88 can be disposed on sides of circuit boards 20 opposite facing sides of circuit boards 20 to avoid obstructing light 70 passing between circuit boards 20, as shown for example in FIG. 17.

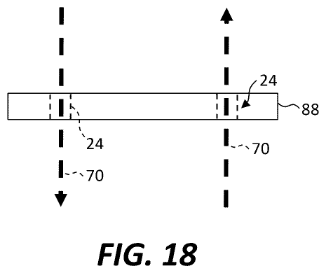

In some embodiments of data-center communication system 10 comprising more than two circuit boards 20 disposed in a stack, one or more cooling blocks 88 can comprise holes (e.g., optical vias 24) or can be transparent (at least partially to light 70, e.g., 50%, 70%, 80%, or 90% transparent to light 70) so that light 70 can pass through cooling block(s) 88, for example as shown in FIG. 18.

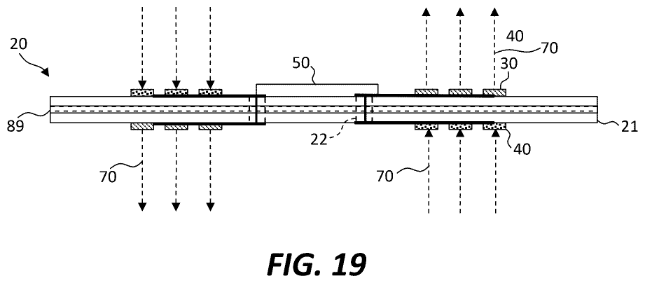

In some embodiments, for example corresponding to FIG. 3B, circuit board 20 can receive light 70 from one side and emit light 70 from an opposite side or, as in FIG. 4, receive light 70 from both sides and emit light 70 from both sides of circuit board 20. In embodiments, and as shown in FIG. 19 for example, therefore, circuit boards 20 can be cooled, for example with one or more channels 89 disposed within circuit-board substrate 21. Any communication connections passing through circuit-board substrate 21, for example through electrical vias 22 or optical vias 34, can be routed around channel(s) 89 or channels 89 can be routed around electrical vias 22 or optical vias 24 (especially optical vias 24).

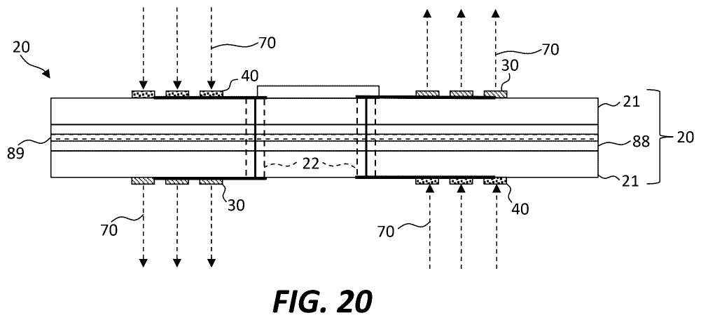

As shown in FIG. 20, circuit boards 20 with one or more cooling channels 89 can comprise multiple layers (e.g., having multiple circuit-board substrates 21) with a cooling structure (e.g., cooling block 88 with cooling channel(s) 89) disposed between and optionally in contact with ones of the multiple circuit-board substrates 21. Chilled fluid 72 passing through channels 89 in cooling block 88 (or circuit-board substrate 21) can cool components disposed on circuit-board substrates 21, improving the performance of data-center communication system 10.

Note that the increased bandwidth is additional to the conventional communication through input/output circuit 64 and optical fiber 68. Furthermore, because optical transmitters 30 and optical receivers 40 can be micro-devices assembled by micro-transfer printing, the area of circuit-board substrate 21 needed to support orthogonal optical communication between circuit boards 20 in rack 80 can be relatively small, for example less than one mm by one mm so that the greatly increased communication bandwidth between circuit boards 20 in rack 80 does not require much space on circuit-board substrate 21, although the control electronics for the additional communication will also require additional space on circuit-board substrate 21.

Optical transmitters 30 can be or comprise light-emitting diodes (e.g., inorganic light-emitting diodes), lasers, vertical-cavity surface-emitting lasers, or laser diodes. Optical transmitters 30 can be constructed in a compound semiconductor photolithographic process. Optical receivers 40 can be photodiodes, phototransistors, or photosensors. Optical receivers 40 can be constructed in a semiconductor photolithographic process, for example silicon or a compound semiconductor depending on the wavelength. Optical transmitters 30 can emit light 70 having a frequency that can be captured by optical receivers 40.

In embodiments of the present disclosure, optical transmitters 30 and optical receivers 40 can be disposed directly on and non-native to circuit-board substrate 21, for example by micro-transfer printing. In some embodiments, an array 30R of optical transmitters 30 can be disposed on a transmitter substrate 32, either by micro-transfer printing and non-native to transmitter substrate 32 (comprising a non-semiconductor material) or made in or on and native to transmitter substrate 32 (and comprising a semiconductor material), transmitter substrate 32 can be disposed on circuit-board substrate 21 (e.g., by pick-and-place or surface-mount techniques), and electrically connected to integrated circuits on circuit-board substrate 21, for example using thin-film interconnects. Similarly, in some embodiments, an array 40R of optical receivers 40 can be disposed on a receiver substrate 42, either by micro-transfer printing and non-native to receiver substrate 42 (comprising a non-semiconductor material) or made in or on and native to receiver substrate 42 (and comprising a semiconductor material such as silicon), receiver substrate 42 can be disposed on circuit-board substrate 21 (e.g., by pick-and-place or surface-mount techniques), and electrically connected to integrated circuits on circuit-board substrate 21, for example using thin-film interconnects. By using an intermediate substrate (e.g., transmitter substrate 32 or receiver substrate 42, or both), the optical communication system can be tested before integrating the optical communication system on circuit-board substrate 21, thereby increasing yields and reducing manufacture costs.

Individual elements of data-center communication system 10 can be constructed using photolithographic methods and materials known in the integrated circuit, display, and optical communication arts. The elements can be assembled on corresponding substrates using micro-transfer printing or printed-circuit board assembly processes such as pick-and-place and surface-mount technologies.

Optical transmitters 30 can be substantially identical, e.g., within manufacturing limits. Similarly, optical receivers 40 can be substantially identical, e.g., within manufacturing limits. In some embodiments, circuit boards 20 can comprise no fewer than 9, 16, 25, 100, 400, 900, 1600, 2500, 5625, or 10000 optical transmitters 30, optical receivers 40, or both, arranged in rows or columns having no fewer than 3, 5, 10, 25, 100, 200, 300, 400, or 500 optical transmitters 30, optical receivers 40, or both in each row or column.

Having described certain implementations of embodiments, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific elements, or where processes and methods are described as having, including, or comprising specific steps, it is contemplated that, additionally, there are apparatus and systems of the disclosed technology that consist essentially of, or consist of, the recited elements, and that there are processes and methods according to the disclosed technology that consist essentially of, or consist of, the recited processing steps.

It should be understood that the order of steps or order for performing certain action is immaterial so long as operability is maintained. Moreover, two or more steps or actions in some circumstances can be conducted simultaneously. The disclosure has been described in detail with particular reference to certain embodiments thereof, but it will be understood that variations and modifications can be effected within the spirit and scope of the disclosure.

### PARTS LIST

10 data-center communication system
20 circuit board
20A first circuit board
20B second circuit board
20C third circuit board
20D fourth circuit board
20X X^{th} circuit board
21 circuit-board substrate
22 electrical via
24 optical via
26 optical system/lens(es)
27 patterned dielectric structure
28 electrode
29 contact pad
30 optical transmitter/light emitter
30A first optical transmitter
30B second optical transmitter
30C third optical transmitter
30D fourth optical transmitter
30R array of optical transmitters
30X optical transmitter frequency R
30Y optical transmitter frequency G
30Z optical transmitter frequency B
32 transmitter substrate
40 optical receiver/light sensor
40A first optical receiver
40B second optical receiver
40C third optical receiver
40D fourth optical receiver
40R array of optical receivers
40X optical receiver frequency R
40Y optical receiver frequency G
40Z optical receiver frequency B
42 receiver substrate
50 transmitter/receiver controller
50R receiver controller
50T transmitter controller
52 row controller
54 column controller
56 array controller
58 group (subset) of optical transmitters/receivers
60 processor/storage/communication/routing circuit/integrated circuit
62 wire bus/waveguide bus
64 input/output circuit
66 wire
68 optical fiber
70 light/light ray/light beam/optical signal
70A first light/first optical signal
70B second light/second optical signal
70C third light/third optical signal
70R array of light beams/array of optical signals
72 chilled fluid
80 rack
82 slides
84 mount
86 light-absorbing wall
88 cooling block
89 channel
92 tether
100 provide data-center communication system step
110 input data from external source to circuit boards step
120 process/retrieve data on circuit boards step
130 communicate data to adjacent circuit boards step
140 output data to external source from circuit board step

1. A data-center communication system, comprising:
a first circuit board comprising an optical transmitter operable to emit light; and
a second circuit board comprising an optical receiver operable to receive the light,
wherein the first circuit board and the second circuit board are disposed in a fixed spatial relationship.

2. The data-center communication system of claim 1, wherein the optical transmitter is a first optical transmitter, the optical receiver is a first optical receiver, and the light is first light, and
wherein the second circuit board comprises a second optical transmitter operable to emit second light from the second circuit board to the first circuit board; and
wherein the first circuit board comprises a second optical receiver operable to receive the second light.

3. The data-center communication system of claim 1, wherein the first circuit board comprises a first circuit-board substrate having opposing parallel surfaces, the second circuit board comprises a second circuit-board substrate having opposing parallel surfaces that are parallel to the opposing parallel surfaces of the first circuit-board substrate, the optical transmitter is disposed on a first surface of the first circuit-board substrate, the optical receiver is disposed on a second surface of the second circuit-board substrate, and the first circuit-board substrate and the second circuit-board substrate are stacked so that a direction from the first circuit-board substrate to the second circuit-board substrate is at least partially orthogonal to the first surface.

4. The data-center communication system of claim 3, wherein the optical transmitter is disposed on a first surface of the circuit-board substrate of the first circuit board, the optical receiver is disposed on a second surface of the circuit-board substrate of the second circuit board, and the first surface and the second surface are adjacent.

5. The data-center communication system of claim 3, wherein (i) the second circuit board is disposed in a direction orthogonal to a surface of the first circuit-board substrate, (ii) the first circuit board and the second circuit board have a substantially same circuit-board substrate size, or (iii) both (i) and (ii).

6. The data-center communication system of claim 1, wherein at least a portion of the circuit-board substrate of the second circuit board is at least partially transparent to light emitted by the optical transmitter and the optical receiver on the second circuit board is disposed on a surface of the second circuit board opposite a surface of the second circuit board adjacent to the first circuit board.

7. The data-center communication system of claim 1, wherein the first circuit board comprises one or more electrically or optically connected computing components or storage components, and wherein one or more of the computing components and storage components, or both, are connected to the optical transmitter.

8. The data-center communication system of claim 1, wherein the second circuit board comprises one or more electrically or optically connected computing components or storage components, and wherein one or more of the computing components and storage components, or both, are connected to the optical receiver.

9. The data-center communication system of claim 1, comprising (i) a plurality of optical transmitters disposed on the first circuit board operable to emit light from the first circuit board to the second circuit board; (ii) a plurality of optical receivers disposed on the second circuit board operable to receive light transmitted from the first circuit board to the second circuit board; or (iii) both (i) and (ii).

10. The data-center communication system of claim 9, wherein (i) each of the optical receivers disposed on the second circuit board is disposed to receive light from a corresponding one of the light transmitters disposed on the first circuit board or (ii) an exclusive subset of the optical receivers disposed on the second circuit board is disposed to receive light from a corresponding one of the light transmitters disposed on the first circuit board.

11. (canceled)

12. The data-center communication system of claim 1, comprising a third circuit board and (i) a light receiver disposed on the third circuit board to receive light from the first circuit board, (ii) a light transmitter disposed on the third circuit board disposed to transmit light to the first circuit board, or (iii) both (i) and (ii).

13. The data-center communication system of claim 12, wherein the second circuit board is (i) at least partially transparent to light emitted by the light transmitter on the first circuit board, (ii) at least partially transparent to light emitted by the light transmitter on the third circuit board, or (iii) both (i) and (ii).

14. The data-center communication system of claim 12, wherein the optical transmitter disposed on the first circuit board is a first optical transmitter and comprising a second optical transmitter disposed on the second circuit board operable to emit light from the second circuit board to the third circuit board.

15. The data-center communication system of claim 12, wherein the light emitted from the first circuit board to the second circuit board is an optical signal and wherein the light emitted from the second circuit board to the third circuit board transmits substantially the same optical signal.

16. The data-center communication system of claim 12, wherein the second circuit board comprises a hole through which emitted light can pass.

17. The data-center communication system of claim 12, wherein transmit/receive pairs of optical transmitters and optical receivers are in a fixed spatial relationship and different transmit/receive pairs are disposed in unrelated locations on their respective circuit boards.

18. The data-center communication system of claim 12, wherein transmit/receive pairs of optical transmitters and optical receivers on each circuit board in a stack of circuit boards form an optical bus.

19. The data-center communication system of claim 1, wherein the circuit boards comprise four circuit boards each having a surface, and the four circuit boards are arranged as the sides of a square with the surfaces facing the inside of the square.

20-21. (canceled)

22. The data-center communication system of claim 19, wherein the four circuit boards are a data square and comprising a plurality of data squares, each data square operable to transmit or receive light from another data square.

23. (canceled)

24. The data-center communication system of claim 19, wherein the circuit boards comprise six circuit boards each having a surface, and the six circuit boards are arranged as the sides of a cube with the surfaces facing the inside of the cube.

25-63. (canceled)
